(19) United States
(12) Patent Application Publication
(10) Pub. No.: US 2025/0024557 A1
(43) Pub. Date: Jan. 16, 2025

(54) METHOD AND DEVICE IN COMMUNICATION NODE FOR WIRELESS COMMUNICATION

(71) Applicants: Qiaoling YU, Shanghai (CN); Xiaobo ZHANG, Shanghai (CN)

(72) Inventors: Qiaoling YU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/896,947

(22) Filed: Sep. 26, 2024

Related U.S. Application Data
(63) Continuation of application No. PCT/CN2023/085840, filed on Apr. 3, 2023.

(30) Foreign Application Priority Data
Apr. 2, 2022 (CN) 202210351270.1

(51) Int. Cl. H04W 76/38; H04B 7/06

(52) U.S. Cl. CPC H04W 76/38; H04B 7/0626

(57) ABSTRACT

The present application provides a method and a device in a communication node for wireless communications. A communication node receives a first signaling which is used to determine a first TA, starts or restarts a first timer which is used to determine whether an uplink of the first resource group is aligned; receives a second signaling which is used to determine a second TA, starts or restarts a second timer which is used to determine whether an uplink of a second resource group is aligned; when the first timer expires, determines whether to execute a first action set or a second action set according to the second timer; the first action set is related to both the first resource group and the second resource group; the second action set is related to the first resource group, and the second action set is unrelated to the second resource group.

### CROSS REFERENCE TO RELATED APPLICATIONS

The present application is the continuation of the international patent application No. PCT/CN2023/085840, filed on Apr. 3, 2023, and claims the priority benefit of Chinese Patent Application No. 202210351270.1, filed on Apr. 2, 2022, the full disclosure of which is incorporated herein by reference.

### BACKGROUND

### Technical Field

The present application relates to transmission methods and devices in wireless communication systems, and in particular to Multiple Input Multiple Output (MIMO) transmission methods and devices.

### Related Art

MIMO is a key technology for NR (New Radio) systems and has been successfully commercialized. In Rel (Release)-15/16/17, 3GPP (3rd Generation Partner Project) has carried out standardization work on MIMO features for FDD (Frequency Division Duplex) and TDD (Time Division Duplex) systems, with the main focus on downlink (DL) MIMO operation. In Rel-18, research on MIMO for Uplink (UL) is a very important research direction for 3GPP, and 3GPP RAN94e meeting decided to carry out the research project of “MIMO Evolution for Downlink and Uplink”. Uplink multiple Transmit/Receive Point (multi-TRP) deployments with two Timing Advances (TA) and enhanced uplink power control to provide extra uplink performance gains need further research.

### SUMMARY

In existing protocols, a Cell Group (CG) of a User Equipment (UE) can be configured with multiple Timing Advance Groups (TAGs). Each cell in the Cell Group is configured to a TAG, and each TAG uses a timeAlignmentTimer to determine whether uplinks of all cells of the TAG are aligned. When a timeAlignmentTimer expires, it triggers operations for all cells of a TAG associated with the timeAlignmentTimer or for all cells in a cell group to which a TAG associated with the timeAlignmentTimer belongs. If the UE performs uplink transmission through two TRPs (Transmission/Receiver Points) with different TAs, the existing TA maintenance mechanism is difficult to adjust a TA of an uplink for each TRP. Therefore, it is necessary to enhance the maintenance of the TA of the uplink for each TRP.

In response to the above issues, the present application provides a solution for maintaining the TA of the uplink for each TRP. In view of the above problem, MIMO scenario is used as an example: the present application is also applicable to scenarios such as multi-connectivity, where similar technical effects can be achieved. Though originally targeted at Uu air interface, the present application is also applicable to PC5 interface. Besides, the present application is not only targeted at scenarios of terminals and base stations, but also at Vehicle-to-Everything (V2X) scenarios, terminals and relays as well as communication scenarios between relays and base stations, where similar technical effect can be achieved. Furthermore, although the original intention of the present application is for scenarios of terminal and base station, the present application is also applicable to communication scenarios of Integrated Access and Backhaul (IAB), where similar technical effects can be achieved. Furthermore, although the original intention of the present application is to Terrestrial Network (TN) scenarios, it is also applicable to communication scenarios of Non-Terrestrial Network (NTN), where similar technical effects can be achieved. Additionally, the adoption of a unified solution for various scenarios contributes to the reduction of hardware complexity and costs.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict.

The present application provides a method in a first node for wireless communications, comprising:
receiving a first signaling, the first signaling being used to indicate a first TA; and
as a response to the first TA being received, determining an uplink transmission timing of a first resource group according to the first TA, starting or restarting a first timer, and a running state of the first timer being used to determine whether an uplink associated with the first resource group is aligned; as a response to an expiration of the first timer, determining whether to execute a first action set or a second action set according to at least a number of resource group(s) in a first cell;
herein, the first cell comprises at least one resource group, and each resource group in the at least one resource group comprises at least one radio resource; the first resource group is one of the at least one resource group: the behavior of determining whether to execute a first action set or a second action set according to at least a number of resource group(s) in a first cell comprises: if a number of resource group(s) in the first cell is equal to 1, executing the first action set, the first action set being related to the first cell; if a number of resource group(s) in the first cell is greater than 1, executing the second action set, the second action set being related to the first resource group, and the second action set being unrelated to a resource group other than the first resource group in the first cell.

In one embodiment, a problem to be solved in the present application comprises: how to maintain the TA of the uplink for each TRP.

In one embodiment, a problem to be solved in the present application comprises: how to shorten the uplink transmission delay;

In one embodiment, a problem to be solved in the present application comprises: how to avoid resource waste.

In one embodiment, characteristics of the above method comprise: independently maintaining TAs of uplinks of two TRPs.

In one embodiment, characteristics of the above method comprise: the first action set and the second action set are different.

In one embodiment, advantages of the above method comprise: shortening the uplink transmission delay:

In one embodiment, advantages of the above method comprise: avoiding resource waste.

In one embodiment, advantages of the above method comprise: the uplink of each TRP is maintained independently to avoid the impact of uplink out-of-step of one TRP on uplink transmission of another TRP.

According to one aspect of the present application, it is characterized in that the first action set comprises flushing all HARQ (Hybrid Automatic Repeat Request) buffers associated with the first cell; the second action set comprises flushing all HARQ buffers associated with the first resource group.

According to one aspect of the present application, it is characterized in that the first action set comprises notifying an upper layer to release all first-type resources associated with the first cell; the second action set comprises notifying an upper layer to release all first-type resources associated with the first resource group; the first-type resource comprises at least one of a PUCCH (Physical Uplink Control Channel) or an SRS (Sounding Reference Signal).

According to one aspect of the present application, it is characterized in that the first action set comprises deleting all second-type resources associated with the first cell; the second action set comprises deleting all second-type resources associated with the first resource group; the second-type resource comprises at least one of a configured downlink assignment, or a configured uplink grant, or PUSCH (Physical Uplink Shared Channel) resources for semi-persistent CSI (Channel State Information) reporting.

In one embodiment, the first action set comprises at least one of flushing all HARQ buffers associated with the first cell, or notifying an upper layer to release all first-type resources associated with the first cell, or deleting all second-type resources associated with the first cell.

In one embodiment, the second action set comprises at least one of flushing all HARQ buffers associated with the first resource group, or notifying an upper layer to release all first-type resources associated with the first resource group, or deleting all second-type resources associated with the first resource group.

According to one aspect of the present application, comprising:
receiving a second signaling, the second signaling being used to determine a second TA; and
as a response to the second TA being received, determining an uplink transmission timing of a second resource group according to the second TA, starting or restarting a second timer, and a running state of the second timer being used to determine whether an uplink associated with the second resource group is aligned;
herein, the second resource group is one of the at least one resource group; any radio resource in the first resource group is different from any radio resource in the second resource group.

In one embodiment, characteristics of the above method comprise: each TRP in a cell independently maintaining a timer is used to determine whether an uplink transmission is aligned.

In one embodiment, advantages of the above method comprise: a TA of each TRP in a cell can be updated independently.

According to one aspect of the present application, comprising:
as a response to an expiration of the first timer, if a number of resource group(s) in the first cell is greater than 1, determining whether to execute a third action set according to at least one of whether the second timer is running or a type of the first cell, the third action set being related to a second cell;
herein, the first cell and the second cell belong to a first cell group, and the second cell is any cell other than the first cell in the first cell group; the action of determining whether to execute a third action set according to at least one of whether the second timer is running or a type of the first cell comprises: if at least the second timer is not running and the first cell is a primary cell in the first cell group, executing the third action set.

In one embodiment, characteristics of the above method comprise: when a first timer expires, only when the second timer is not running and the first cell is a primary cell in the first cell group are satisfied; executing the third action set; a number of resource group(s) in the first cell is equal to 2.

In one embodiment, characteristics of the above method comprise: when a first timer expires, if the first cell is a primary cell in the first cell group, but the second timer is running, the third action set is not executed.

In one embodiment, advantages of the above method comprise: reducing the impact of the expiration of a first timer on uplink transmissions of other cells.

According to one aspect of the present application, it is characterized in that the third action set comprises at least one of flushing all HARQ buffers associated with the second cell, or considering that a third timer is expired, or notifying an upper layer to release all first-type resources associated with the second cell; a running state of the third timer is used to determine whether an uplink associated with a third resource group is aligned, and the third resource group is associated with the second cell.

According to one aspect of the present application, comprising:
receiving a third signaling, the third signaling being used to determine that the first resource group is associated with a first TAG and the second resource group is associated with a second TAG;
herein, the first TAG is different from the second TAG.

In one embodiment, characteristics of the above method comprise: the first resource group associated with the first cell and the second resource group to which it belongs are configured in two different TAGs.

In one embodiment, characteristics of the above method comprise: the first cell is associated to two TAGs.

In one embodiment, advantages of the above method comprise: reusing the definition for TAG in 3GPP protocol and reducing the impact on standards.

According to one aspect of the present application, comprising:
as a response to an expiration of the first timer, if a number of resource group(s) in the first cell is equal to 1, determining whether to execute a third action set according to a type of the first cell, the third action set being related to a second cell;
herein, the first cell and the second cell belong to a first cell group, and the second cell is any cell other than the first cell in the first cell group; the action of determining whether to execute a third action set according to a type of the first cell comprises: if the first cell is a primary cell in the first cell group, executing the third action set; if the first cell is a secondary cell in the first cell group, the third action set not being executed.

According to one aspect of the present application, comprising:
transmitting at least a first radio signal according to an uplink transmission timing of the first resource group, the first radio signal being a physical-layer signal; a number of resource group(s) in the first cell being greater than 1.

According to one aspect of the present application, comprising:
transmitting at least a second radio signal according to an uplink transmission timing of the second resource group, the second radio signal being a physical-layer signal; a number of resource group(s) in the first cell being greater than 1.

The present application provides a method in a second node for wireless communications, comprising:
transmitting a first signaling, the first signaling being used to indicate a first TA;
herein, as a response to the first TA being received, an uplink transmission timing of a first resource group is determined by a receiver of the first signaling according to the first TA, a first timer is started or restarted by a receiver of the first signaling, and a running state of the first timer is used to determine whether an uplink associated with the first resource group is aligned; as a response to an expiration of the first timer, at least a number of resource group(s) in a first cell is used to determine whether to execute a first action set or a second action set; the first cell comprises at least one resource group, and each resource group in the at least one resource group comprises at least one radio resource: the first resource group is one of the at least one resource group; the phrase that at least a number of resource group(s) in a first cell is used to determine whether to execute a first action set or a second action set comprises: if a number of resource group(s) in the first cell is equal to 1, the first action set being executed, the first action set being related to the first cell; if a number of resource group(s) in the first cell is greater than 1, the second action set being executed, the second action set being related to the first resource group, and the second action set being unrelated to a resource group other than the first resource group in the first cell.

According to one aspect of the present application, it is characterized in that the first action set comprises flushing all HARQ buffers associated with the first cell; the second action set comprises flushing all HARQ buffers associated with the first resource group.

According to one aspect of the present application, it is characterized in that the first action set comprises notifying an upper layer to release all first-type resources associated with the first cell; the second action set comprises notifying an upper layer to release all first-type resources associated with the first resource group; the first-type resource comprises at least one of a PUCCH or an SRS.

According to one aspect of the present application, it is characterized in that the first action set comprises deleting all second-type resources associated with the first cell; the second action set comprises deleting all second-type resources associated with the first resource group; the second-type resource comprises at least one of a configured downlink assignment, or a configured uplink grant, or PUSCH resources for semi-persistent CSI reporting.

According to one aspect of the present application, it is characterized in that transmit a second signaling, the second signaling is used to determine a second TA;
herein, as a response to the second TA being received, an uplink transmission timing of a second resource group is determined by a receiver of the first signaling according to the second TA, and a second timer is started or restarted by a receiver of the first signaling, a running state of the second timer is used to determine whether an uplink associated with the second resource group is aligned; the second resource group is one of the at least one resource group; any radio resource in the first resource group is different from any radio resource in the second resource group.

According to one aspect of the present application, it is characterized in that as a response to an expiration of the first timer, if a number of resource group(s) in the first cell is greater than 1, at least one of whether the second timer is running or a type of the first cell is used to determine whether to execute a third action set, and the third action set is related to a second cell; the first cell and the second cell belong to a first cell group, and the second cell is any cell other than the first cell in the first cell group; the phrase of at least one of whether the second timer is running or a type of the first cell is used to determine whether to perform a third action set comprises: if at least the second timer is not running and the first cell is a primary cell in the first cell group, the third action set is executed.

According to one aspect of the present application, it is characterized in that the third action set comprises at least one of flushing all HARQ buffers associated with the second cell, or considering that a third timer is expired, or notifying an upper layer to release all first-type resources associated with the second cell; a running state of the third timer is used to determine whether an uplink associated with a third resource group is aligned, and the third resource group is associated with the second cell.

According to one aspect of the present application, comprising:
transmitting a third signaling, the third signaling being used to determine that the first resource group is associated with a first TAG and the second resource group is associated with a second TAG;
herein, the first TAG is different from the second TAG.

According to one aspect of the present application, it is characterized in that as a response to an expiration of the first timer, if a number of resource group(s) in the first cell is equal to 1, a type of the first cell is used to determine whether to execute a third action set, and the third action set is related to a second cell; herein, the first cell and the second cell belong to a first cell group, and the second cell is any cell other than the first cell in the first cell group; the phrase that a type of the first cell is used to determine whether to execute a third action set comprises: if the first cell is a primary cell in the first cell group, the third action set is executed; if the first cell is a secondary cell in the first cell group, the third action set is not executed.

The present application provides a first node for wireless communications, comprising:
a first receiver, receiving a first signaling, the first signaling being used to indicate a first TA; and
a first transmitter, as a response to the first TA being received, determining an uplink transmission timing of a first resource group according to the first TA, starting or restarting a first timer, and a running state of the first timer being used to determine whether an uplink associated with the first resource group is aligned; as a response to an expiration of the first timer, determining whether to execute a first action set or a second action set according to at least a number of resource group(s) in a first cell;
herein, the first cell comprises at least one resource group, and each resource group in the at least one resource group comprises at least one radio resource; the first resource group is one of the at least one resource group; the behavior of determining whether to execute a first action set or a second action set according to at least a number of resource group(s) in a first cell comprises: if a number of resource group(s) in the first cell is equal to 1, executing the first action set, the first action set being related to the first cell; if a number of resource group(s) in the first cell is greater than 1, executing the second action set, the second action set being related to the first resource group, and the second action set being unrelated to a resource group other than the first resource group in the first cell.

The present application provides a second node for wireless communications, comprising:
a second transmitter, transmitting a first signaling, the first signaling being used to indicate a first TA;
herein, as a response to the first TA being received, an uplink transmission timing of a first resource group is determined by a receiver of the first signaling according to the first TA, a first timer is started or restarted by a receiver of the first signaling, and a running state of the first timer is used to determine whether an uplink associated with the first resource group is aligned; as a response to an expiration of the first timer, at least a number of resource group(s) in a first cell is used to determine whether to execute a first action set or a second action set; the first cell comprises at least one resource group, and each resource group in the at least one resource group comprises at least one radio resource; the first resource group is one of the at least one resource group; the phrase that at least a number of resource group(s) in a first cell is used to determine whether to execute a first action set or a second action set comprises: if a number of resource group(s) in the first cell is equal to 1, the first action set being executed, the first action set being related to the first cell; if a number of resource group(s) in the first cell is greater than 1, the second action set being executed, the second action set being related to the first resource group, and the second action set being unrelated to a resource group other than the first resource group in the first cell.

In one embodiment, the present application has the following advantages over conventional schemes:
shortening uplink transmission delay;
avoiding resource waste;
a TA of each TRP in a cell can be updated independently;
reducing the impact of expiration of a first timer on uplink transmission of other cells;
independently maintaining the uplink of each TRP to avoid the impact of uplink out-of-step of one TRP on uplink transmission of another TRP;
reusing the definition for TAG in 3GPP protocol and reducing the impact on standards.

### BRIEF DESCRIPTION OF THE DRAWINGS

Other features, objects and advantages of the present application will become more apparent from the detailed description of non-restrictive embodiments taken in conjunction with the following drawings:

FIG. 1 is a flowchart of transmission of a first signaling according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrates a flowchart of radio signal transmission according to another embodiment of the present application;

FIG. 7 illustrates a flowchart of radio signal transmission according to another embodiment of the present application;

FIG. 8 illustrates a flowchart of radio signal transmission according to another embodiment of the present application;

FIG. 9 illustrates a schematic diagram of a third action set being related to a second cell according to one embodiment of the present application;

FIG. 10 illustrates a structure block diagram of a processor in a first node according to one embodiment of the present application;

FIG. 11 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

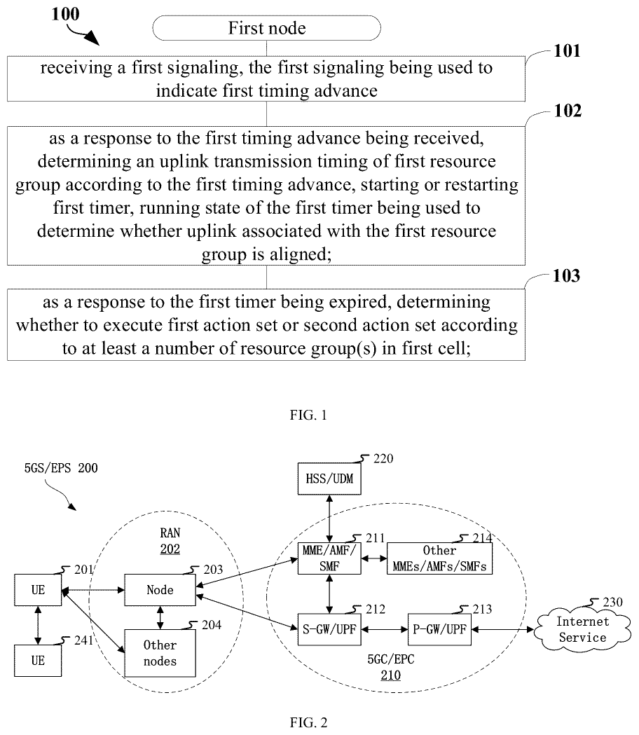

Embodiment 1 illustrates a schematic diagram of transmission of a first signaling according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, a first node in the present application receives a first signaling in step 101, and the first signaling is used to determine a first TA; in step 102, as a response to the first TA being received, determines an uplink transmission timing of a first resource group according to the first TA, and starts or restarts a first timer, a running state of the first timer is used to determine whether an uplink associated with the first resource group is aligned; in step 103, as a response to an expiration of the first timer, determines whether to execute a first action set or a second action set according to at least a number of resource group(s) in a first cell; herein, the first cell comprises at least one resource group, and each resource group in the at least one resource group comprises at least one radio resource; the first resource group is one of the at least one resource group; the behavior of determining whether to execute a first action set or a second action set according to at least a number of resource group(s) in a first cell comprises: if a number of resource group(s) in the first cell is equal to 1, executing the first action set, the first action set being related to the first cell; if a number of resource group(s) in the first cell is greater than 1, executing the second action set, the second action set being related to the first resource group, and the second action set being unrelated to a resource group other than the first resource group in the first cell. In one embodiment, a transmitter of the first signaling is a maintenance base station of the first cell.

In one embodiment, a transmitter of the first signaling is a maintenance base station of a serving cell of the first node.

In one embodiment, a transmitter of the first signaling is a maintenance base station of the first cell.

In one embodiment, a transmitter of the first signaling is a maintenance base station of a cell in the first cell group.

In one embodiment, a transmitter of the first signaling is a maintenance base station of an additional cell of a serving cell of the first node.

In one embodiment, the first signaling comprises a MAC (Medium Access Control) layer signaling.

In one embodiment, the first signaling comprises at least one MAC Protocol Data Unit (PDU).

In one embodiment, the first signaling comprises at least a MAC subPDU.

In one embodiment, the first signaling comprises at least one MAC subheader.

In one embodiment, the first signaling comprises a physical-layer signaling.

In one embodiment, the first signaling comprises at least one MAC Control Element (CE).

In one embodiment, the first signaling comprises a first MAC field, and the first MAC field is used to determine the first TA.

In one subembodiment of the embodiment, the first MAC field indicates an index of the second TA.

In one subembodiment of the embodiment, the first MAC field comprises a positive integer number of bit(s).

In one subembodiment of the embodiment, the first MAC field comprises 5 bits.

In one subembodiment of the embodiment, the first MAC field comprises 6 bits.

In one subembodiment of the embodiment, the first MAC field comprises 11 bits.

In one subembodiment of the embodiment, the first MAC field comprises 12 bits.

In one subembodiment of the embodiment, an index of the first TA is a TA value.

In one subembodiment of the embodiment, an index of the first TA is a non-negative integer.

In one embodiment, the first signaling is Timing Advance Command MAC CE, and the first MAC field is a field in Timing Advance Command MAC CE.

In one embodiment, the first signaling is an Absolute Timing Advance Command MAC CE, and the first MAC field is a field in an Absolute Timing Advance Command MAC CE.

In one embodiment, the first signaling is a MAC RAR (Random Access Response), and the first MAC field is a field in a MAC RAR.

In one embodiment, the first signaling is an MSGB (Message B), and the first MAC field is a field in an MSGB.

In one embodiment, the first signaling is fallbackRAR, and the first MAC field is a field in fallbackRAR.

In one embodiment, the first signaling is successRAR, and the first MAC field is a field in successRAR.

In one embodiment, the first signaling comprises the first MAC field, the first signaling comprises the second MAC field, and the second MAC field is used to determine a TAG.

In one subembodiment of the embodiment, the second MAC field is used to determine a TAG to which the first TA comprised in the first MAC field belongs.

In one subembodiment of the embodiment, the second MAC field indicates an index of a TAG to which the first resource group belongs.

In one subembodiment of the embodiment, the second MAC field indicates an identifier of a TAG to which the first resource group belongs.

In one subembodiment of the embodiment, the second MAC field indicates a TAG-Id associated with the first resource group.

In one embodiment, the behavior of determining an uplink transmission timing of a first resource group according to the first TA comprises: determining an uplink transmission timing of the first resource group according to at least the first TA.

In one embodiment, the behavior of determining an uplink transmission timing of a first resource group according to the first TA comprises: adjusting an uplink transmission timing of the first resource group according to the first TA.

In one embodiment, the behavior of determining an uplink transmission timing of a first resource group according to the first TA comprises: calculating an uplink transmission timing of the first resource group according to the first TA.

In one embodiment, the behavior of determining an uplink transmission timing of a first resource group according to the first TA comprises: determining a transmission time of an uplink signal associated with the first resource group according to the first TA.

In one embodiment, the behavior of determining an uplink transmission timing of a first resource group according to the first TA comprises: determining a transmission time of a PUCCH, an SRS, or a PUSCH associated with the first resource group according to the first TA.

In one embodiment, the behavior of determining an uplink transmission timing of a first resource group according to the first TA comprises: determining an uplink transmission timing of the first resource group according to the first TA and a maintained N_{TA}.

In one embodiment, the first signaling indicates a first T_{A}, and an uplink transmission timing of the first resource group is determined according to at least the first T_{A}.

In one embodiment, the first signaling indicates a first T_{A}, and the first T_{A} is a first N_{TA}, the first N_{TA}=first T_{A}·16·64/2^{μ}; an uplink transmission timing of the first resource group is determined according to the first N_{TA}, the first T_{A} is an index value of the first T_{A}, and a first T_{A}=0, 1, 2, . . . , 3846.

In one embodiment, the first signaling indicates a first T_{A}, and the first TA is (first T_{A}−31)·16·64/2^{μ}; an uplink transmission timing of the first resource group is determined according to a first N_{TA_new}, first N_{TA_new}=first N_{TA_old}+ (first T_{A}−31)·16·64/2^{μ}, the first N_{TA} old is maintained, the first T_{A} is an index value of the first TA, and first T_{A}=0, 1, 2, . . . , 63.

In one embodiment, the μ₁ is related to a subcarrier spacing (SCS).

In one embodiment, the μ₁ is related to an SCS associated with the first resource group.

In one embodiment, the μ₁ is a non-negative integer.

In one embodiment, the μ₁ is an integer not less than 0 and not greater than 5.

In one embodiment, the behavior of starting or restarting a first timer comprises: if the first timer is not running, starting the first timer.

In one embodiment, the behavior of starting or restarting a first timer comprises: if the first timer is running, restarting the first timer.

In one embodiment, the first timer is a timer in MAC layer.

In one embodiment, the first timer is a TAT.

In one embodiment, the first timer is a time alignment timer.

In one embodiment, a running state of the first timer is used to determine whether an uplink associated with the first TAG is aligned; the first resource group is associated with the first TAG.

In one embodiment, a running state of the first timer comprises that the first timer is running.

In one embodiment, a running state of the first timer comprises that the first timer is not running.

In one subembodiment of the embodiment, the first timer not running comprises that the first timer is expired.

In one subembodiment of the embodiment, the first timer not running comprises that the first timer is not started.

In one embodiment, the first timer being running is used to determine that an uplink associated with the first resource group is aligned.

In one embodiment, the first timer not being running is used to determine that an uplink associated with the first resource group is not aligned.

In one embodiment, the uplink alignment comprises an uplink transmission synchronization.

In one embodiment, the uplink misalignment comprises an uplink transmission out of sync.

In one embodiment, the first timer being expired refers to that the first timer reaches an expiration time of the first timer.

In one embodiment, an expiration of the first timer refers to a timing of the first timer being equal to an expiration value of the first timer, when the first timer is started or restarted, a timing is incremented from 0.

In one embodiment, an expiration of the first timer refers to a timing of the first timer being equal to 0, when the first timer is started or restarted, the timing is decremented from an expiration value of the first timer.

In one embodiment, an expiration of the first timer refers to a time elapsed since the first timer is started or restarted reaching its expiration value.

In one embodiment, an expiration value of the first timer is configured through a dedicated signaling.

In one embodiment, an expiration value of the first timer is configured through a broadcast signaling.

In one embodiment, an expiration value of the first timer is configured through an RRC message.

In one embodiment, an expiration value of the first timer is configurable.

In one embodiment, an expiration value of the first timer is pre-configured.

In one embodiment, the first timer reaching an expiration value of the first timer is used to determine an expiration of the first timer. In one embodiment, a number of resource group(s) comprised in the first cell is configurable.

In one embodiment, a number of resource group(s) comprised in the first cell is fixed.

In one embodiment, a number of resource group(s) comprised in the first cell is predetermined.

In one embodiment, a number of resource group(s) in the first cell is equal to 1.

In one embodiment, a number of resource group(s) in the first cell is greater than 1.

In one embodiment, a number of resource group(s) in the first cell is equal to 2.

In one embodiment, a number of resource group(s) in the first cell is greater than 2.

In one embodiment, the first cell is a serving cell of the first node.

In one embodiment, the first cell is a serving cell in the first cell group.

In one embodiment, the first Cell Group is a Master Cell Group (MCG) or a Secondary Cell Group (SCG), and the first cell is an SpCell in the first cell group.

In one embodiment, a type of the first cell is a primary cell in the first cell group.

In one embodiment, a type of the first cell is a secondary cell in the first cell group.

In one embodiment, a type of the first cell comprises a primary cell in the first cell group or a secondary cell in the first cell group.

In one embodiment, the primary cell is an SpCell (Special Cell).

In one embodiment, the secondary cell is a Secondary Cell (SCell).

In one embodiment, the first cell group is an MCG, a primary cell in the first cell group is a PCell (Primary Cell), and a secondary cell in the first cell group is an SCell.

In one embodiment, the first cell group is an SCG, a primary cell in the first cell group is a PSCell (Primary SCG Cell), and a secondary cell in the first cell group is an SCell.

In one embodiment, the first cell group is an MCG, and the first cell is a PCell in the first cell group.

In one embodiment, the first cell group is an SCG, and the first cell is a PSCell in the first cell group.

In one embodiment, the first cell group is an MCG, and the first cell is an SCell in the first cell group.

In one embodiment, the first cell group is an SCG, and the first cell is an SCell in the first cell group.

In one embodiment, each resource group comprised in each cell in the first cell group comprises at least one radio resource.

In one embodiment, a number of resource group(s) comprised in each cell in the first cell group is equal.

In one embodiment, a number of resource group(s) comprised in each cell in the first cell group is configurable.

In one embodiment, a number of resource group(s) comprised in each cell in the first cell group is equal to 1 or 2.

In one embodiment, there exists at least one cell whose comprised number of resource group(s) is greater than 1 in the first cell group.

In one embodiment, the first node is configured with a ServCellIndex, the ServCellIndex indicates the first cell.

In one embodiment, as a response to an expiration of the first timer, determine whether to execute a first action set or a second action set only according to a number of resource group(s) in the first cell.

In one embodiment, as a response to an expiration of the first timer, determine whether to execute the first action set or the second action set according to a number of resource group(s) in the first cell and a type of the first cell.

In one embodiment, as a response to an expiration of the first timer, determine whether to execute the first action set or the second action set according to a number of resource group(s) in the first cell and whether the second timer in the present application is running.

In one embodiment, the first cell comprises only one resource group or multiple resource groups.

In one embodiment, the first cell only comprises the first resource group.

In one embodiment, the first cell only comprises the first resource group and the second resource group.

In one embodiment, the first cell comprises at least the first resource group and the second resource group.

In one embodiment, if a number of resource group(s) in the first cell is greater than 1, the second resource group is a resource group other than the first resource group in the first cell.

In one embodiment, each resource group in the at least one resource group is associated with the first cell.

In one embodiment, each resource group in the at least one resource group belongs to the first cell.

In one embodiment, each resource group in the at least one resource group belongs to the first cell or an additional cell of the first cell.

In one subembodiment of the embodiment, a PCI (physical cell identity) of the first cell is different from a PCI of the additional cell of the first cell.

In one subembodiment of the embodiment, the additional cell of the first cell provides extra radio resources for the first cell.

In one subembodiment of the embodiment, the first cell is configured with ServCellIndex, and the additional cell of the first cell is not configured with ServCellIndex.

In one subembodiment of the embodiment, the first cell and the additional cell of the first cell are configured with same ServCellIndex.

In one subembodiment of the embodiment, the first cell is configured with ServCellIndex, and the additional cell of the first cell is associated with ServCellIndex of the first cell.

In one subembodiment of the embodiment, the first cell is an SCell or an SpCell, and the additional cell of the first cell is not an SCell or an SpCell.

In one subembodiment of the embodiment, the first cell is configured with at least one SSB (SS/PBCH block) belonging to the additional cell of the first cell.

In one subembodiment of the embodiment, the first cell is configured with at least one CSI-RS (CSI reference signal) belonging to the additional cell of the first cell.

In one subembodiment of the embodiment, the first node is configured with an SSB in the first cell, the SSB is configured by CSI-SSB-ResourceSet IE, the CSI-SSB-ResourceSet IE comprises an RRC (Radio Resource Control) field, and the RRC field is used to indicate that the SSB belongs to the additional cell of the first cell.

In one subembodiment of the embodiment, the RRC field is set as a cell identifier of the additional cell of the first cell.

In one subembodiment of the embodiment, the RRC field is set as a PCI (physical cell identity) of the additional cell of the first cell.

In one subembodiment of the embodiment, a name of the RRC field comprises additionalPCI.

In one subembodiment of the embodiment, a name of the RRC field comprises additionalPCIIndex.

In one embodiment, any resource group in the at least one resource group does not belong to an additional cell of the first cell.

In one embodiment, an additional cell of the first cell is not configured.

In one embodiment, each resource group in the at least one resource group is associated with a TAG.

In one embodiment, all uplink transmissions of a PUCCH, an SRS, or a PUSCH corresponding to each resource group in the at least one resource group adopts a same T_{A}.

In one embodiment, if a number of resource group(s) in the first cell is greater than 1, an uplink transmission of a PUCCH, an SRS, or a PUSCH corresponding to any resource group in the at least one resource group and an uplink transmission of a PUCCH, an SRS, or a PUSCH corresponding to another resource group in the at least one resource group adopt different TAs.

In one embodiment, each radio resource in each resource group of the at least one resource group is an uplink resource.

In one embodiment, each radio resource in each resource group of the at least one resource group is a downlink resource.

In one embodiment, each radio resource in each resource group of the at least one resource group is a beam.

In one embodiment, each radio resource in each resource group of the at least one resource group is an antenna port.

In one embodiment, each radio resource in each resource group of the at least one resource group is a reference signal resource.

In one embodiment, each radio resource in each resource group of the at least one resource group is an uplink reference signal resource.

In one embodiment, each radio resource in each resource group of the at least one resource group is a downlink reference signal resource.

In one embodiment, each radio resource in each resource group of the at least one resource group is an SSB resource.

In one embodiment, each radio resource in each resource group of the at least one resource group is a CSI-RS resource.

In one embodiment, each radio resource in each resource group of the at least one resource group is an SSB resource or a CSI-RS resource.

In one embodiment, each radio resource in each resource group of the at least one resource group is a reference signal of a PUCCH, an SRS, or a PUSCH, and the reference signal is an SSB or a CSI-RS.

In one embodiment, each radio resource in each resource group of the at least one resource group is used to transmit a reference signal of a PUCCH, an SRS, or a PUSCH.

In one embodiment, each radio resource in each resource group of the at least one resource group is used for uplink transmission.

In one embodiment, each radio resource in each resource group of the at least one resource group is used for PRACH transmission.

In one embodiment, each radio resource in each resource group of the at least one resource group is used for PRACH transmission of CFRA.

In one embodiment, each radio resource in each resource group of the at least one resource group is used for PRACH transmission of CBRA.

In one embodiment, each radio resource in each resource group of the at least one resource group comprises a frequency-domain resource.

In one embodiment, each radio resource in each resource group of the at least one resource group comprises a time-domain resource.

In one embodiment, each radio resource in each resource group of the at least one resource group comprises a code-domain resource.

In one embodiment, each radio resource in each resource group of the at least one resource group comprises a spatial-domain resource.

In one embodiment, each radio resource in each resource group of the at least one resource group comprises a power resource.

In one embodiment, each radio resource in each resource group of the at least one resource group comprises at least one of frequency-domain resource, time-domain resource, code-domain resource, or spatial-domain resource.

In one embodiment, the spatial-domain resource comprises an antenna port.

In one embodiment, the spatial-domain resource comprises a port.

In one embodiment, the spatial-domain resource comprises a panel.

In one embodiment, each radio resource in each resource group of the at least one resource group comprises spatial setting.

In one embodiment, each radio resource in each resource group of the at least one resource group comprises Spatial Relation Information.

In one embodiment, each radio resource in each resource group of the at least one resource group is associated with an SSB or CSI-RS.

In one embodiment, the first action set is related to the first resource group, and the first cell only comprises the first resource group.

In one embodiment, the first action set is related to each HARQ buffer in the first cell.

In one embodiment, the first action set is related to each PUCCH in the first cell.

In one embodiment, the first action set is related to each SRS in the first cell.

In one embodiment, the first action set is related to an uplink grant of each configuration in the first cell.

In one embodiment, the first action set is related to a downlink assignment of each configuration in the first cell.

In one embodiment, the first action set is related to PUSCH resources of each semi-persistent CSI reporting in the first cell.

In one embodiment, receive a first signaling, the first signaling is used to indicate a first TA; as a response to the first TA being received, determine an uplink transmission timing of a first resource group according to the first TA, and start or restart a first timer, a running state of the first timer is used to determine whether an uplink associated with the first resource group is aligned; as a response to an expiration of the first timer, execute the first action set, the first action set is related to the first cell; herein, the first cell comprises at least one resource group, and each resource group in the at least one resource group comprises at least one radio resource; the first resource group is one of the at least one resource group; a number of resource group(s) in the first cell is equal to 1.

In one embodiment, the second action set is related to the first resource group, and the first cell comprises at least 2 resource groups.

In one embodiment, the phrase that if a number of resource group(s) in the first cell is greater than 1 comprises: if a number of resource group(s) in the first cell is equal to 2.

In one embodiment, the phrase that if a number of resource group(s) in the first cell is greater than 1 comprises: if a number of resource group(s) in the first cell is not less than 2.

In one embodiment, the phrase that if a number of resource group(s) in the first cell is greater than 1 comprises: if a number of resource group(s) in the first cell is not equal to 1.

In one embodiment, the second action set is for the first resource group, and the second action set is not for a resource group other than the first resource group in the first cell.

In one embodiment, the second action set is related to the first resource group.

In one embodiment, each action in the second action set is related to the first resource group.

In one embodiment, at least one action in the second action set is related to the first resource group.

In one embodiment, each action in the second action set is independent of a resource group other than the first resource group in the first cell.

In one embodiment, the second action set is related to each HARQ buffer in the first resource group.

In one embodiment, the second action set is related to each PUCCH in the first resource group.

In one embodiment, the second action set is related to each SRS in the first resource group.

In one embodiment, the second action set is related to an uplink grant of each configuration in the first resource group.

In one embodiment, the second action set is related to a downlink allocation of each configuration in the first resource group.

In one embodiment, the second action set is related to PUSCH resources of each semi-persistent CSI reporting in the first resource group.

In one embodiment, receive a first signaling, the first signaling is used to indicate a first TA; as a response to the first TA being received, determine an uplink transmission timing of a first resource group according to the first TA, and start or restart a first timer, a running state of the first timer is used to determine whether an uplink associated with the first resource group is aligned; as a response to an expiration of the first timer, execute the second action set, the second action set is related to the first resource group, and the second action set is unrelated to a resource group other than the first resource group in the first cell; the first cell comprises at least one resource group, and each resource group in the at least one resource group comprises at least one radio resource; the first resource group is one of the at least one resource group; a number of resource group(s) in the first cell is greater than 1.

In one embodiment, the uplink alignment comprises: uplink synchronization.

In one embodiment, the uplink alignment comprises: uplink transmission timing is accurate.

In one embodiment, the uplink misalignment comprises: uplink out-of-step.

In one embodiment, the uplink misalignment comprises: uplink transmission timing is inaccurate.

In one embodiment, each time alignment timer is for a cell; a number of resource group(s) in the first cell is equal to 1.

In one embodiment, each time alignment timer is for a resource group; a number of resource group(s) in the first cell is greater than 1.

In one embodiment, each the time alignment timer comprises timeAlignmentTimer.

In one embodiment, each the time alignment timer is timeAlignmentTimer.

In one embodiment, a name of each the time alignment timer comprises at least one of time, Alignment, Timer, TRP, set, 1, or 2.

### Embodiment 2

Embodiment 2 illustrates a schematic diagram of a network architecture according to one embodiment of the present application, as shown in FIG. 2. FIG. 2 is a diagram illustrating a network architecture 200 of 5G NR/Long-Term Evolution (LTE)/Long-Term Evolution Advanced (LTE-A) systems. The 5G NR/LTE/LTE-A network architecture 200 may be called a 5G System (5GS)/Evolved Packet System (EPS) 200 or other appropriate terms. The 5GS/EPS 200 comprises at least one of a UE 201, an RAN 202, a 5G Core Network/Evolved Packet Core (5GC/EPC) 210, a Home Subscriber Server (HSS)/Unified Data Management (UDM) 220 or an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The RAN comprises the node 203 and other nodes 204. The node 203 provides UE 201—oriented user plane and control plane protocol terminations. The node 203 may be connected to other nodes 204 via an Xn interface (e.g., backhaul)/X2 interface. The node 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The node 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The node 203 is connected to the 5GC/EPC 210 via an SI/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 is a UE.

In one embodiment, the node 203 corresponds to the second node in the present application.

In one embodiment, the node 203 is a BaseStation (BS).

In one embodiment, the node 203 is a Base Transceiver Station (BTS).

In one embodiment, the node 203 is a NodeB (NB).

In one embodiment, the node 203 is a gNB.

In one embodiment, the node 203 is an eNB.

In one embodiment, the node 203 is a ng-eNB.

In one embodiment, the node 203 is an en-gNB.

In one embodiment, the node 203 is a UE.

In one embodiment, the node 203 is a relay.

In one embodiment, the node 203 is a gateway.

In one embodiment, the UE supports Terrestrial Network (TN) transmission.

In one embodiment, the UE supports Non-Terrestrial Network (NTN) transmission.

In one embodiment, the UE supports communications within networks with large latency differences.

In one embodiment, the UE supports Dual Connection (DC) transmission.

In one embodiment, the UE comprises an aircraft.

In one embodiment, the UE comprises a vehicle terminal.

In one embodiment, the UE comprises a vessel.

In one embodiment, the UE comprises an Internet of Things (IoT) terminal.

In one embodiment, the UE comprises an Industrial Internet of Things (IIoT) terminal.

In one embodiment, the UE comprises a device supporting transmission with low-latency and high-reliability.

In one embodiment, the UE comprises test equipment.

In one embodiment, the UE comprises a signaling tester.

In one embodiment, the base station supports transmission over NTN.

In one embodiment, the base station supports transmission over networks with large-latency differences.

In one embodiment, the base station supports transmission over TN.

In one embodiment, the base station comprises a Marco Cellular base station.

In one embodiment, the base station comprises a Micro Cell base station.

In one embodiment, the base station comprises a Pico Cell base station.

In one embodiment, the base station comprises a Femtocell.

In one embodiment, the base station comprises a base station supporting large-latency differences.

In one embodiment, the base station comprises flight platform equipment.

In one embodiment, the base station comprises satellite equipment.

In one embodiment, the base station comprises a Transmitter Receiver Point (TRP).

In one embodiment, the base station comprises a Centralized Unit (CU).

In one embodiment, the base station comprises a Distributed Unit (DU).

In one embodiment, the base station comprises test equipment.

In one embodiment, the base station comprises a signaling tester.

In one embodiment, the base station comprises an Integrated Access and Backhaul (IAB)-node.

In one embodiment, the base station comprises an IAB-donor.

In one embodiment, the base station comprises an IAB-donor-CU.

In one embodiment, the base station comprises an IAB-donor-DU.

In one embodiment, the base station comprises an IAB-DU.

In one embodiment, the base station comprises an IAB-MT.

In one embodiment, the relay comprises a relay.

In one embodiment, the relay comprises an L3 relay.

In one embodiment, the relay comprises an L2 relay.

In one embodiment, the relay comprises a router.

In one embodiment, the relay comprises a switch.

In one embodiment, the relay comprises a UE.

In one embodiment, the relay comprises a base station.

### Embodiment 3

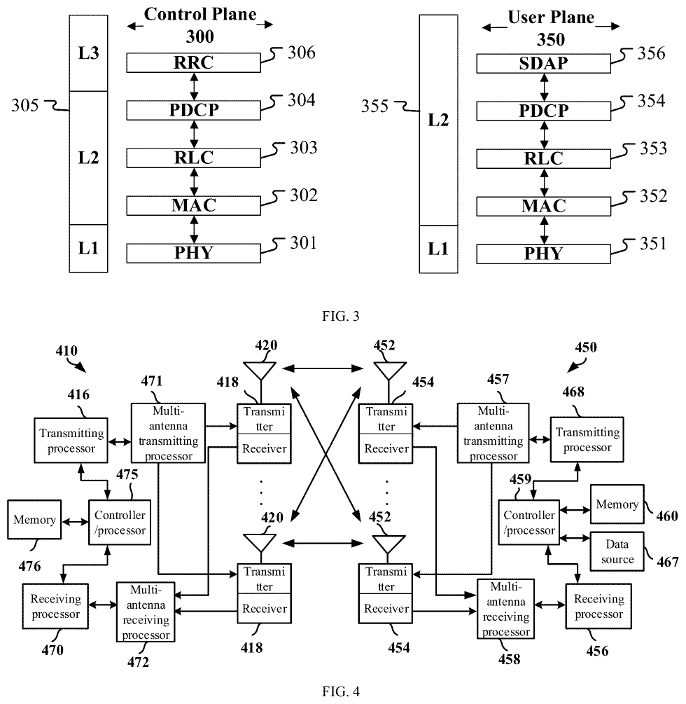

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for the control plane 300 is represented by three layers, which are a layer 1, a layer 2 and a layer 3, respectively. The layer 1 (L1) is the lowest layer and performs signal processing functions of various PHY layers. The L1 is called PHY 301 in the present application. L2 305, above the PHY 301, comprises a Medium Access Control (MAC) sublayer 302, a Radio Link Control (RLC) sublayer 303 and a Packet Data Convergence Protocol (PDCP) sublayer 304. The PDCP sublayer 304 provides multiplexing among variable radio bearers and logical channels. The PDCP sublayer 304 provides security by encrypting a data packet and provides support for handover. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating various radio resources (i.e., resources block) in a cell. The MAC sublayer 302 is also in charge of HARQ operation. The RRC sublayer 306 in L3 layer of the control plane 300 is responsible for acquiring radio resources (i.e., radio bearer) and configuring the lower layer with an RRC signaling. The radio protocol architecture of the user plane 350 comprises layer 1 (L1) and layer 2 (L2). In the user plane 350, the radio protocol architecture is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic.

In one embodiment, the radio protocol architecture in FIG. 3 is applicable to the first node in the present application.

In one embodiment, the radio protocol architecture in FIG. 3 is applicable to the second node in the present application.

In one embodiment, the first signaling in the present application is generated by the RRC 306.

In one embodiment, the first signaling in the present application is generated by the MAC 302 or the MAC 352.

In one embodiment, the first signaling in the present application is generated by the PHY 301 or the PHY 351.

In one embodiment, the second signaling in the present application is generated by the RRC 306.

In one embodiment, the second signaling in the present application is generated by the MAC 302 or the MAC 352.

In one embodiment, the second signaling in the present application is generated by the PHY 301 or the PHY 351.

In one embodiment, the third signaling in the present application is generated by the RRC 306.

In one embodiment, the third signaling in the present application is generated by the MAC 302 or the MAC 352.

In one embodiment, the third signaling in the present application is generated by the PHY 301 or the PHY 351.

In one embodiment, the first radio signal in the present application is generated by the PHY 301 or the PHY 351.

In one embodiment, the second radio signal in the present application is generated by the PHY 301 or the PHY 351.

### Embodiment 4

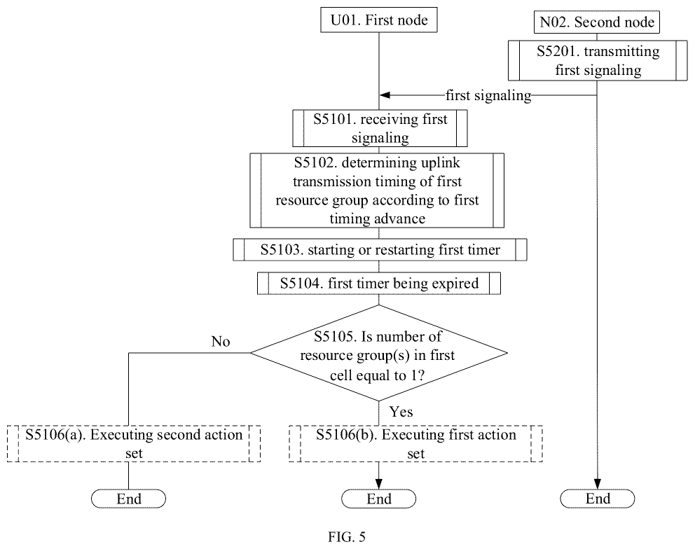

Embodiment 4 illustrates a schematic diagram of a first communication device and a second communication device in the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410 side, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises at least one processor and at least one memory; at least one processor and at least one memory. The at least one memory comprises computer program codes; the at least one memory and the computer program codes are configured to be used in collaboration with the at least one processor, the first communication device 450 at least: receives a first signaling, the first signaling is used to indicate a first TA; as a response to the first TA being received, determines an uplink transmission timing of a first resource group according to the first TA, and starts or restarts a first timer, a running state of the first timer is used to determine whether an uplink associated with the first resource group is aligned; as a response to an expiration of the first timer, determines whether to execute a first action set or a second action set according to at least a number of resource group(s) in a first cell; herein, the first cell comprises at least one resource group, and each resource group in the at least one resource group comprises at least one radio resource; the first resource group is one of the at least one resource group; the behavior of determining whether to execute a first action set or a second action set according to at least a number of resource group(s) in a first cell comprises: if a number of resource group(s) in the first cell is equal to 1, executing the first action set, the first action set being related to the first cell; if a number of resource group(s) in the first cell is greater than 1, executing the second action set, the second action set being related to the first resource group, and the second action set being unrelated to a resource group other than the first resource group in the first cell.

In one embodiment, the first communication device 450 comprises at least one processor and at least one memory. a memory that stores a computer readable instruction program. The computer readable instruction program generates an action when executed by at least one processor. The action includes: receiving a first signaling, the first signaling being used to indicate a first TA; as a response to the first TA being received, determining an uplink transmission timing of a first resource group according to the first TA, starting or restarting a first timer, and a running state of the first timer being used to determine whether an uplink associated with the first resource group is aligned; as a response to an expiration of the first timer, determining whether to execute a first action set or a second action set according to at least a number of resource group(s) in a first cell; herein, the first cell comprises at least one resource group, and each resource group in the at least one resource group comprises at least one radio resource; the first resource group is one of the at least one resource group; the behavior of determining whether to execute a first action set or a second action set according to at least a number of resource group(s) in a first cell comprises: if a number of resource group(s) in the first cell is equal to 1, executing the first action set, the first action set being related to the first cell; if a number of resource group(s) in the first cell is greater than 1, executing the second action set, the second action set being related to the first resource group, and the second action set being unrelated to a resource group other than the first resource group in the first cell.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: transmits a first signaling, the first signaling is used to indicate a first TA; herein, as a response to the first TA being received, an uplink transmission timing of a first resource group is determined by a receiver of the first signaling according to the first TA, a first timer is started or restarted by a receiver of the first signaling, and a running state of the first timer is used to determine whether an uplink associated with the first resource group is aligned; as a response to an expiration of the first timer, at least a number of resource group(s) in a first cell is used to determine whether to execute a first action set or a second action set; the first cell comprises at least one resource group, and each resource group in the at least one resource group comprises at least one radio resource; the first resource group is one of the at least one resource group; the phrase that at least a number of resource group(s) in a first cell is used to determine whether to execute a first action set or a second action set comprises: if a number of resource group(s) in the first cell is equal to 1, the first action set being executed, the first action set being related to the first cell; if a number of resource group(s) in the first cell is greater than 1, the second action set being executed, the second action set being related to the first resource group, and the second action set being unrelated to a resource group other than the first resource group in the first cell.

In one embodiment, the second communication device 410 comprises a memory that stores a computer readable instruction program. The computer readable instruction program generates an action when executed by at least one processor. The action includes: transmitting a first signaling, the first signaling being used to indicate a first TA; herein, as a response to the first TA being received, an uplink transmission timing of a first resource group is determined by a receiver of the first signaling according to the first TA, a first timer is started or restarted by a receiver of the first signaling, and a running state of the first timer is used to determine whether an uplink associated with the first resource group is aligned; as a response to an expiration of the first timer, at least a number of resource group(s) in a first cell is used to determine whether to execute a first action set or a second action set; the first cell comprises at least one resource group, and each resource group in the at least one resource group comprises at least one radio resource; the first resource group is one of the at least one resource group; the phrase that at least a number of resource group(s) in a first cell is used to determine whether to execute a first action set or a second action set comprises: if a number of resource group(s) in the first cell is equal to 1, the first action set being executed, the first action set being related to the first cell; if a number of resource group(s) in the first cell is greater than 1, the second action set being executed, the second action set being related to the first resource group, and the second action set being unrelated to a resource group other than the first resource group in the first cell.

In one embodiment, the antenna 452, the receiver 454, the receiving processor 456, the controller/processor 459 are used to receive a first signaling; at least one of the antenna 420, the transmitter 418, the transmitting processor 416, or the controller/processor 475 is used to transmit the first signaling.

In one embodiment, the antenna 452, the receiver 454, the receiving processor 456, and the controller/processor 459 are used to receive a second signaling; at least one of the antenna 420, the transmitter 418, the transmitting processor 416, or the controller/processor 475 is used to transmit a second signaling.

In one embodiment, the antenna 452, the receiver 454, the receiving processor 456, and the controller/processor 459 are used to receive a third signaling; at least one of the antenna 420, the transmitter 418, the transmitting processor 416, or the controller/processor 475 is used to transmit a third signaling.

In one embodiment, the antenna 452, the transmitter 454, the transmitting processor 468, and the controller/processor 459 are used to transmit a first radio signal; at least one of the antenna 420, the receiver 418, the receiving processor 470, or the controller/processor 475 is used to receive a first radio signal.

In one embodiment, the antenna 452, the transmitter 454, the transmitting processor 468, and the controller/processor 459 are used to transmit a second radio signal; at least one of the antenna 420, the receiver 418, the receiving processor 470, or the controller/processor 475 is used to receive a second radio signal.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a UE that supports large delay differences.

In one embodiment, the first communication device 450 is a UE that supports NTN.

In one embodiment, the first communication device 450 is an aircraft device.

In one embodiment, the first communication device 450 has a positioning capability.

In one embodiment, the first communication device 450 does not have a positioning capability.

In one embodiment, the first communication device 450 is a UE that supports TN.

In one embodiment, the second communication device 410 is a base station (gNB/eNB/ng-eNB).

In one embodiment, the second communication device 410 is a base station that supports large delay differences.

In one embodiment, the second communication device 410 is a base station that supports NTN.

In one embodiment, the second communication device 410 is satellite equipment.

In one embodiment, the second communication device 410 is flying platform equipment.

In one embodiment, the second communication device 410 is a base station that supports TN.

### Embodiment 5

Embodiment 5 illustrates a flowchart of radio signal transmission according to one embodiment in the present application, as shown in FIG. 5. It is particularly underlined that the order illustrated in the embodiment does not put constraints over sequences of signal transmissions and implementations.

The first node U01 receives a first signaling in step S5101, and the first signaling is used to determine a first TA; in step S5102, as a response to the first TA being received, determines an uplink transmission timing of a first resource group according to the first TA, in step S5103, as a response to the first TA being received, starts or restarts a first timer, and a running state of the first timer is used to determine whether an uplink associated with the first resource group is aligned; in step S5104, as a response to an expiration of the first timer, in step S5105, determines whether to execute a first action set or a second action set according to at least a number of resource group(s) in a first cell, when a number of resource group(s) in the first cell is equal to 1, enters step S5106 (b) to execute a first action set, otherwise enters step S5106 (a) to execute a second action set.

The second node N02 transmits the first signaling in step S5201.

In embodiment 5, the first cell comprises at least one resource group, and each resource group in the at least one resource group comprises at least one radio resource; the first resource group is one of the at least one resource group; the behavior of determining whether to execute a first action set or a second action set according to at least a number of resource group(s) in a first cell comprises: if a number of resource group(s) in the first cell is equal to 1, executing the first action set, the first action set being related to the first cell; if a number of resource group(s) in the first cell is greater than 1, executing the second action set, the second action set being related to the first resource group, and the second action set being unrelated to a resource group other than the first resource group in the first cell.

In one embodiment, the first node U01 is a UE.

In one embodiment, the first node U01 is a relay device.

In one embodiment, the first node U01 is a base station.

In one embodiment, the second node N02 is a base station.

In one embodiment, the second node N02 is a UE.

In one embodiment, the second node N02 is a base station.

In one embodiment, the first node U01 is a UE, and the second node N02 is a base station device.

In one embodiment, the first node U01 is a UE, and the second node N02 is a relay.

In one embodiment, the first node U01 is a base station, and the second node N02 is a base station device.

In one embodiment, the second node N02 comprises at least one TRP.

In one embodiment, the second node N02 comprises one TRP.

In one embodiment, the second node N02 comprises two TRPs.

In one embodiment, the first resource group and the second resource group are respectively associated with two different TRPs of a maintenance base station of the first cell.

In one embodiment, the first resource group is associated with a TRP of a maintenance base station of the first cell; the second resource group is associated with a TRP of a maintenance base station of an additional cell of the first cell.

In one embodiment, the second resource group is associated with a TRP of a maintenance base station of the first cell; the first resource group is associated with a TRP of a maintenance base station of an additional cell of the first cell.

In one embodiment, the first action set comprises flushing all HARQ buffers associated with the first cell; the second action set comprises flushing all HARQ buffers associated with the first resource group.

In one embodiment, as a response to an expiration of the first timer, if a number of resource group(s) in the first cell is equal to 1, clear all HARQ buffers associated with the first cell.

In one embodiment, as a response to an expiration of the first timer, if a number of resource group(s) in the first cell is greater than 1, at least all HARQ buffers associated with a resource group other than the first resource group in the first cell are not flushed.

In one embodiment, the second action set comprises flushing only all HARQ buffers associated with the first resource group.

In one embodiment, the second action set comprises flushing all HARQ buffers associated with the first resource group, and the second action set does not comprise flushing all HARQ buffers associated with a resource group other than the first resource group in the first cell.

In one embodiment, one HARQ buffer corresponds to one HARQ process, and the HARQ process is associated with a resource group in the first cell.

In one embodiment, a DCI (Downlink Control Information) is used to determine a resource group to which the HARQ process is associated.

In one subembodiment of the embodiment, the DCI explicitly indicates a resource group to which the HARQ process is associated.

In one subembodiment of the embodiment, the DCI explicitly indicates whether the HARQ process is associated with the first resource group or the second resource group; the at least one resource group is two resource groups.

In one subembodiment of the embodiment, a field in the DCI comprises an index, the index indicating a resource group; if an index indicates the resource group, the HARQ process is associated with the resource group.

In one subembodiment of the embodiment, a field in the DCI comprises an index, the index indicating the first resource group or the second resource group; if the index indicates the first resource group, the HARQ process is associated with the first resource group, and if the index indicates the second resource group, the HARQ process is associated with the second resource group; the at least one resource group is two resource groups.

In one subsidiary embodiment of the subembodiment, another field in the DCI comprises a HARQ process identifier, a HARQ process identifier being used to indicate the HARQ process: the DCI is scrambled by a C-RNTI (Cell RNTI), or the DCI is scrambled by an MCS-RNTI (Modulation and Coding Scheme RNTI), or a CS-RNTI (Configured Scheduling RNTI).

In one subsidiary embodiment of the subembodiment, the DCI is scrambled by a TC-RNTI (Temporary RNTI).

In one subsidiary embodiment of the subembodiment, a format of the DCI comprises DCI format 0_0.

In one subembodiment of the embodiment, the DCI implicitly indicates a resource group to which the HARQ process is associated.

In one subembodiment of the embodiment, the DCI implicitly indicates whether the HARQ process is associated with the first resource group or the second resource group; the at least one resource group is two resource groups.

In one subembodiment of the embodiment, DM-RS (Demodulation Reference Signal) antenna port properties of a PDCCH used to receive the DCI are used to determine a resource group to which a HARQ process is associated.

In one subembodiment of the embodiment, DM-RS antenna port properties used to receive a PDCCH of the DCI are used to determine whether the HARQ process is associated with the first resource group or the second resource group; the at least one resource group is two resource groups.

In one subembodiment of the embodiment, spatial parameters of a PDCCH used to receive the DCI are used to determine a resource group to which a HARQ process is associated.

In one subembodiment of the embodiment, spatial parameters of a PDCCH used to receive the DCI are used to determine whether the HARQ process is associated with the first resource group or the second resource group; the at least one resource group is two resource groups.

In one embodiment, a HARQ process ID is used to indicate the HARQ process, and the HARQ process ID is used to identify a resource group to which the HARQ process is associated.

In one embodiment, a HARQ process identifier is used to indicate the HARQ process, and the HARQ process is used to determine whether the HARQ process is associated with the first resource group or the second resource group; the at least one resource group is two resource groups.

In one subembodiment of the embodiment, the HARQ process identifier is not less than 0, and the HARQ process identifier is not greater than N1, N1 being a positive integer.

In one subembodiment of the embodiment, the HARQ process identifier is not less than 1, and the HARQ process identifier is not greater than N1, N1 being a positive integer.

In one subembodiment of the above embodiment, N1 is equal to 15.

In one subembodiment of the above embodiment, N1 is equal to 31.

In one subembodiment of the above embodiment, if the HARQ process identifier is not greater than N2, the HARQ process is associated with the first resource group; if the HARQ process identifier is greater than N2, the HARQ process is associated with the second resource group; N2 is a positive integer and N2 is less than the N1.

In one subembodiment of the above embodiment, if the HARQ process identifier is not less than N2, the HARQ process is associated with the first resource group; if the HARQ process identifier is less than N2, the HARQ process is associated with the second resource group; N2 is a positive integer and N2 is less than the N1.

In one embodiment, the first action set comprises notifying an upper layer to release all first-type resources associated with the first cell; the second action set comprises notifying an upper layer to release all first-type resources associated with the first resource group; the first-type resource comprises at least one of a PUCCH or an SRS.

In one embodiment, the upper layer is an RRC layer.

In one embodiment, the upper layer is a protocol layer above the MAC layer.

In one embodiment, only when at least one first-type resource associated with the first cell is configured, the first action set comprises notifying an upper layer to release all first-type resources associated with the first cell.

In one embodiment, if at least one first-type resource associated with the first cell is configured, the first action set comprises notifying an upper layer to release all first-type resources associated with the first cell.

In one embodiment, if any first-type resource associated with the first cell is not configured, the first action set comprises notifying an upper layer to release all first-type resources associated with the first cell.

In one embodiment, only when at least one first-type resource associated with the first resource group is configured, the second action set comprises notifying an upper layer to release all first-type resources associated with the first resource group.

In one embodiment, if at least one first-type resource associated with the first resource group is configured, the second action set comprises notifying an upper layer to release all first-type resources associated with the first resource group.

In one embodiment, if any first-type resource associated with the first resource group is not configured, the second action set does not comprise notifying an upper layer to release all first-type resources associated with the second resource group.

In one embodiment, as a response to an expiration of the first timer, if a number of resource group(s) in the first cell is equal to 1, notify an upper layer to release all first-type resources associated with the first cell.

In one embodiment, as a response to an expiration of the first timer, if a number of resource group(s) in the first cell is greater than 1, notify an upper layer to release all first-type resources associated with the first resource group.

In one embodiment, as a response to an expiration of the first timer, if a number of resource group(s) in the first cell is greater than 1, at least all first-type resources associated with the second resource group are not released.

In one embodiment, the second action set comprises notifying an upper layer to release all first-type resources only associated with the first resource group.

In one embodiment, the second action set comprises notifying an upper layer to release all first-type resources associated with the first resource group, and the second action set does not comprise notifying an upper layer to release all first-type resources associated with the second resource group.

In one embodiment, whether a first-type resource is associated with the first resource group or the second resource group is explicitly indicated; a number of resource group(s) in the first cell is greater than 1.

In one embodiment, whether a first-type resource is associated with the first resource group or the second resource group is implicitly indicated; a number of resource group(s) in the first cell is greater than 1.

In one embodiment, the first-type resource is configured by an RRC message.

In one embodiment, the first-type resource comprises PUCCH resources or SRS resources.

In one embodiment, the first-type resource comprises PUCCH resources.

In one embodiment, the first-type resource comprises SRS resources.

In one embodiment, the SRS resources are configured by SRS-Config.

In one embodiment, PUCCH resources are configured through PUCCH-Config.

In one embodiment, if a number of resource group(s) in the first cell is equal to 1, any first-type resource associated with the first cell belongs to the first resource group.

In one embodiment, if a number of resource group(s) in the first cell is greater than 1, any first-type resource associated with the first cell belongs to a resource group in the at least one resource group.

In one embodiment, if a number of resource group(s) in the first cell is greater than 1, any first-type resource associated with the first cell belongs to the first resource group or the second resource group; the at least one resource group is two resource groups.

In one embodiment, all first-type resources associated with the first cell are: first-type resources belonging to the first cell.

In one embodiment, all first-type resources associated with the first cell are: first-type resources configured for the first cell.

In one embodiment, all first-type resources associated with the first cell are: first-type resources configured for any TRP in the first cell.

In one embodiment, a first-type resource associated with the first resource group refers to: a first-type resource belonging to the first resource group.

In one embodiment, a first-type resource associated with the first resource group refers to: a first-type resource configured for the first resource group.

In one embodiment, a first-type resource associated with the first resource group refers to: a first-type resource configured for a TRP corresponding to the first resource group.

In one embodiment, a first-type resource associated with the first resource group refers to: a first-type resource configured with an index of the first resource group.

In one embodiment, if a first-type resource is associated with the first resource group, a radio signal carried by the first-type resource is transmitted by a maintenance node of the first resource group.

In one embodiment, a first-type resource associated with the second resource group refers to: a first-type resource belonging to the second resource group.

In one embodiment, a first-type resource associated with the second resource group refers to: a first-type resource configured for the second resource group.

In one embodiment, a first-type resource associated with the second resource group refers to: a first-type resource configured for a TRP corresponding to the second resource group.

In one embodiment, a first-type resource associated with the second resource group refers to: a first-type resource configured with an index of the second resource group.

In one embodiment, if a first-type resource is associated with the second resource group, a radio signal carried by the first-type resource is transmitted by a maintenance node of the second resource group.

In one embodiment, the first action set comprises deleting all second-type resources associated with the first cell; the second action set comprises deleting all second-type resources associated with the first resource group; the second-type resource comprises at least one of a configured downlink assignment, or a configured uplink grant, or PUSCH resources for semi-persistent CSI reporting.

In one embodiment, the deleting means deleting at the MAC layer.

In one embodiment, the deleting means flushing.

In one embodiment, only when at least one second-type resource associated with the first cell is configured, the first action set comprises deleting all second-type resources associated with the first cell.

In one embodiment, if at least one second-type resource associated with the first cell is configured, the first action set comprises deleting all second-type resources associated with the first cell.

In one embodiment, if any second-type resource associated with the first cell is not configured, the first action set does not comprise deleting all second-type resources associated with the first cell.

In one embodiment, only when at least one second-type resource associated with the first resource group is configured, the second action set comprises deleting all second-type resources associated with the first resource group.

In one embodiment, if at least one second-type resource associated with the first resource group is configured, the second action set comprises deleting all second-type resources associated with the first resource group.

In one embodiment, if any second-type resource associated with the first resource group is not configured, the second action set does not comprise deleting all second-type resources associated with the first resource group.

In one embodiment, as a response to an expiration of the first timer, if a number of resource group(s) in the first cell is equal to 1, delete all second-type resources associated with the first cell.

In one embodiment, as a response to an expiration of the first timer, if a number of resource group(s) in the first cell is greater than 1, delete all second-type resources associated with the first resource group.

In one embodiment, as a response to an expiration of the first timer, if a number of resource group(s) in the first cell is greater than 1, at least a second-type resource associated with the second resource group is not deleted.

In one embodiment, the second action set comprises deleting all second-type resources only associated with the first resource group.

In one embodiment, the second action set comprises deleting all second-type resources associated with the first resource group, and the second action set does not comprise deleting all second-type resources associated with the second resource group.

In one embodiment, whether a second-type resource is associated with the first resource group or the second resource group is explicitly indicated; a number of resource group(s) in the first cell is greater than 1.

In one embodiment, whether a second-type resource is associated with the first resource group or the second resource group is implicitly indicated; a number of resource group(s) in the first cell is greater than 1.

In one embodiment, the second-type resource is configured by an RRC message.

In one embodiment, the second-type resources comprise configured downlink assignments.

In one embodiment, the second-type resources comprise configured uplink grants.

In one embodiment, the second-type resource comprises PUSCH resource for semi-persistent CSI reporting.

In one embodiment, any second-type resource associated with the first cell belongs to the first resource group or the second resource group; a number of resource group(s) in the first cell is greater than 1.

In one embodiment, each of all second-type resources associated with the first cell belongs to either the first resource group or the second resource group; a number of resource group(s) in the first cell is greater than 1.

In one embodiment, all second-type resources associated with the first cell comprise all second-type resources associated with the first resource group and all second-type resources associated with the second resource group; a number of resource group(s) in the first cell is greater than 1.

In one embodiment, a second-type resource associated with the first resource group refers to: a second-type resource configured for the first resource group.

In one embodiment, a second-type resource associated with the first resource group refers to: a second-type resource configured for a TRP corresponding to the first resource group.

In one embodiment, a second-type resource associated with the first resource group refers to: a second-type resource configured with an index of the first resource group.

In one embodiment, if a second-type resource is associated with the first resource group, a radio signal carried by the second-type resource is transmitted by a maintenance node of the first resource group.

In one embodiment, a second-type resource associated with the second resource group refers to: a second-type resource configured for the second resource group.

In one embodiment, a second-type resource associated with the second resource group refers to: a second-type resource configured for a TRP corresponding to the second resource group.

In one embodiment, a second-type resource associated with the second resource group refers to: a second-type resource configured with an index of the second resource group.

In one embodiment, if a second-type resource is associated with the second resource group, a radio signal carried by the second-type resource is transmitted by a maintenance node of the second resource group.

In one embodiment, the configured downlink assignment is configured by an RRC message.

In one embodiment, the configured downlink assignment comprises resources configured through SPS-Config.

In one embodiment, the configured downlink assignment comprises resources indicated through SPS-ConfigIndex.

In one embodiment, the configured uplink grant is configured through an RRC message.

In one embodiment, the configured uplink grant is a UL grant.

In one embodiment, the configured uplink grant is a PUSCH resource.

In one embodiment, the configured uplink grant comprises resources configured through ConfiguredGrantConfig.

In one embodiment, the configured uplink grant comprises resources indicated by ConfiguredGrantConfigIndex.

In one embodiment, the PUSCH resources of a semi-persistent CSI reporting are configured through an RRC message.

In one embodiment, the PUSCH resources of a semi-persistent CSI reporting comprise resources configured by CSI-ReportConfig.

In one embodiment, the PUSCH resources of a semi-persistent CSI reporting comprise resources indicated by CSI-ReportConfigId.

In one embodiment, the PUSCH resources of a semi-persistent CSI reporting comprise resources configured by CSI-ResourceConfig.

In one embodiment, the PUSCH resources of a semi-persistent CSI reporting comprise resources indicated by CSI-ResourceConfigId.

In one embodiment, the first action set comprises at least one of flushing all HARQ buffers associated with the first cell, or notifying an upper layer to release all first-type resources associated with the first cell, or deleting all second-type resources associated with the first cell; the second action set comprises at least one of flushing all HARQ buffers associated with the first resource group, or notifying an upper layer to release all first-type resources associated with the first resource group, or deleting all second-type resources associated with the first resource group.

In one embodiment, the first cell is associated with a first TAG; if a number of resource group(s) in the first cell is equal to 1.

In one embodiment, the first resource group is associated with a first TAG and the second resource group is associated with a second TAG; a number of resource group(s) in the first cell is greater than 1.

In one embodiment, the second action set being related to the first TAG is used to determine that the second action set is related to the first resource group; the first resource group is associated with a first TAG and the second resource group is associated with a second TAG; a number of resource group(s) in the first cell is greater than 1.

In one embodiment, the first action set being related to the first TAG is used to determine that the first action set is related to the first cell; the first cell is associated with a first TAG, if a number of resource group(s) in the first cell is equal to 1.

In one embodiment, the first action set comprises flushing all HARQ buffers associated with each cell comprised in the first TAG, the first TAG comprising the first cell; the second action set comprises flushing all HARQ buffers associated with each resource group comprised in the first TAG, and the first TAG comprises the first resource group in the first cell.

In one subembodiment of the embodiment, the second action set comprises flushing all HARQ buffers associated with each resource group comprised in the first TAG, and the second action set does not comprise flushing all HARQ buffers associated with each resource group comprised in the second TAG; the second TAG comprises the second resource group in the first cell.

In one subembodiment of the embodiment, the second action set comprises flushing all HARQ buffers associated with each resource group comprised in the first TAG; a HARQ buffer of a resource group comprised in any TAG other than the first TAG in the first cell group is not flushed.

In one embodiment, the first action set comprises notifying an upper layer to release all first-type resources associated with each cell comprised in the first TAG, where the first TAG comprises the first cell; the second action set comprises notifying an upper layer to release all first-type resources associated with each resource group comprised in the first TAG, where the first TAG comprises the first resource group in the first cell.

In one embodiment, the first action set comprises deleting all second-type resources associated with each cell comprised in the first TAG, where the first TAG comprises the first cell; the second action set comprises deleting all second-type resources associated with each resource group comprised in the first TAG, where the first TAG comprises the first resource group in the first cell.

In one embodiment, the first action set comprises: at least one of flushing all HARQ buffers associated with each cell comprised in the first TAG, or notifying an upper layer to release all first-type resources associated with each cell comprised in the first TAG, or deleting all second-type resources associated with each cell comprised in the first TAG.

In one embodiment, the second action set comprises: at least one of flushing all HARQ buffers associated with each resource group comprised in the first TAG, or notifying an upper layer to release all first-type resources associated with each resource group comprised in the first TAG, or deleting all second-type resources associated with each resource group comprised in the first TAG.

In one embodiment, being associated to a cell refers to: being configured for the cell.

In one embodiment, being associated to a cell refers to: belonging to the cell.

In one embodiment, being associated to a cell refers to: being associated to each resource group in the cell.

In one embodiment, the above cell comprises the first cell.

In one embodiment, the above cell comprises the second cell in the present application.

In one embodiment, being associated with a resource group refers to: being configured for the resource group.

In one embodiment, being associated with a resource group refers to: belonging to the resource group.

In one embodiment, being associated with a resource group refers to: not being associated with a resource group other than the resource group in the first cell.

In one embodiment, the above resource group comprises the first resource group.

In one embodiment, the above resource group comprises the second resource group in the present application.

In one embodiment, the above resource group comprises a resource group in the first cell.

In one embodiment, one of the step S5106 (a) and step S5106 (a) exists.

In one embodiment, the step S5106 (a) and the step S5106 (a) do not exist at the same time.

In one embodiment, the step S5106 (a) is optional.

In one embodiment, the step S5106 (b) is optional.

### Embodiment 6

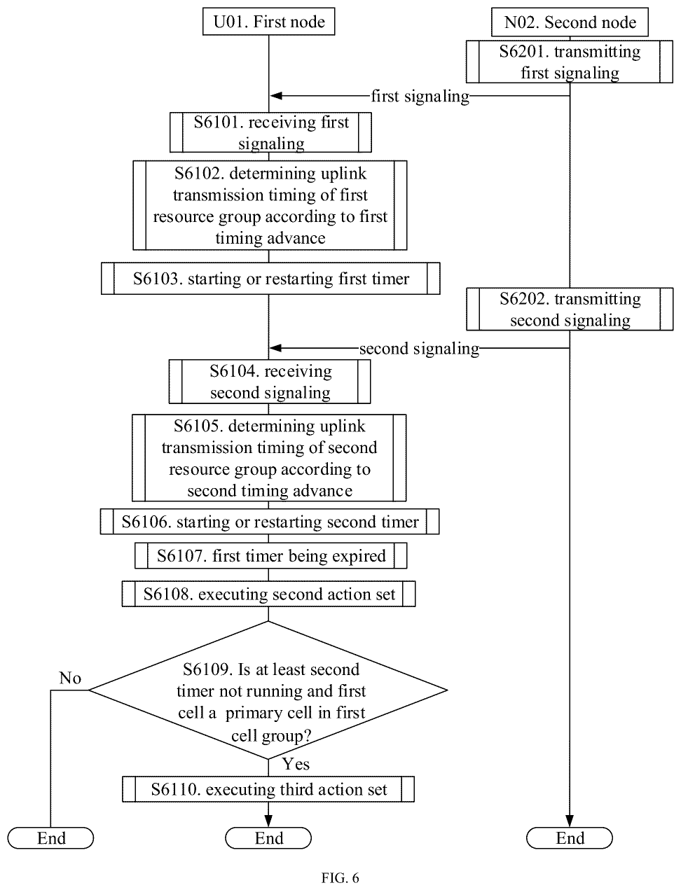

Embodiment 6 illustrates a flowchart of radio signal transmission according to another embodiment of the present application, as shown in FIG. 6. It is particularly underlined that the order illustrated in the embodiment does not put constraints over sequences of signal transmissions and implementations.

The first node U01 receives a first signaling in step S6101, and the first signaling is used to determine a first TA; in step S6102, as a response to the first TA being received, determines an uplink transmission timing of a first resource group according to the first TA, in step S6103, as a response to the first TA being received, starts or restarts a first timer, and a running state of the first timer is used to determine whether an uplink associated with the first resource group is aligned; in step S6104, receives a second signaling, and the second signaling is used to determine a second TA; in step S6105, as a response to receiving the second TA, determines an uplink transmission timing of a second resource group according to the second TA; in step S6106, as a response to the second TA being received, starts or restarts a second timer, a running state of the second timer is used to determine whether an uplink associated with the second resource group is aligned; in step S6107, determines that the first timer expires; in step S6108, as a response to an expiration of the first timer, executes the second action set; in step S6109, determines whether to execute a third action set according to at least one of whether the second timer is running or a type of the first cell, if at least the second timer is not running and the first cell is a primary cell in the first cell group, enters step S6110; in step S6110, executes the third action set, and the third action set is related to a second cell.

The second node N02 transmits the first signaling in step S6201; transmits the second signaling in step S6202.

In embodiment 6, the first cell comprises at least one resource group, and each resource group in the at least one resource group comprises at least one radio resource; the first resource group is one of the at least one resource group; the second action set is related to the first resource group, and the second action set is independent of a resource group other than the first resource group in the first cell; the second resource group is one of the at least one resource group; any radio resource in the first resource group is different from any radio resource in the second resource group; the first cell and the second cell belong to a first cell group, and the second cell is any cell other than the first cell in the first cell group; a number of resource group(s) in the first cell is greater than 1.

In one embodiment, the at least one resource group comprises at least 2 resource groups, and a number of resource group(s) in the first cell is greater than 1.

In one subembodiment of the embodiment, the at least one resource group only comprises 2 resource groups.

In one subembodiment of the embodiment, the at least one resource group comprises more than 2 resource groups.

In one subembodiment of the embodiment, the at least one resource group comprises at least the first resource group and the second resource group.

In one subembodiment of the embodiment, the at least one resource group only comprises the first resource group and the second resource group.

In one embodiment, the first signaling and the second signaling belong to a same MAC PDU.

In one embodiment, the first signaling and the second signaling belong to a same MAC CE.

In one embodiment, the first signaling and the second signaling belong to a same MAC RAR.

In one embodiment, the first signaling and the second signaling belong to a same fallbackRAR.

In one embodiment, the first signaling and the second signaling belong to a same successRAR.

In one embodiment, the first signaling and the second signaling belong to two different MAC PDUs.

In one embodiment, the first signaling comprises a MAC subheader, the second signaling comprises a MAC subheader, and a MAC subheader comprised in the first signaling is different from a MAC subheader comprised in the second signaling.

In one embodiment, the first signaling and the second signaling do not belong to a same MAC CE.

In one embodiment, the first signaling and the second signaling do not belong to a same MAC RAR.

In one embodiment, the first signaling and the second signaling do not belong to a same fallbackRAR.

In one embodiment, the first signaling and the second signaling do not belong to a same successRAR.

In one embodiment, the second signaling is received before the first signaling is received.

In one embodiment, the second signaling is received after the first signaling is received.

In one embodiment, the second signaling is received at the same time as the first signaling.

In one embodiment, a transmitter of the second signaling is a maintenance base station of the first cell.

In one embodiment, a transmitter of the second signaling is a maintenance base station of a serving cell of the first node.

In one embodiment, a transmitter of the second signaling is a maintenance base station of the first cell.

In one embodiment, a transmitter of the second signaling is a maintenance base station of a cell in the first cell group.

In one embodiment, a transmitter of the second signaling is a maintenance base station of an additional cell of a serving cell of the first node.

In one embodiment, the second signaling comprises a MAC layer signaling.

In one embodiment, the second signaling comprises at least one MAC PDU.

In one embodiment, the second signaling comprises at least one MAC subPDU.

In one embodiment, the second signaling comprises at least one MAC subheader.

In one embodiment, the second signaling comprises a physical-layer signaling.

In one embodiment, the second signaling comprises at least one MAC CE.

In one embodiment, the second signaling comprises a third MAC field, and the third MAC field is used to determine the second TA.

In one subembodiment of the embodiment, the third MAC field indicates an index of the second TA.

In one subembodiment of the embodiment, the third MAC field comprises a positive integer number of bit(s).

In one subembodiment of the embodiment, the third MAC field comprises 5 bits.

In one subembodiment of the embodiment, the third MAC field comprises 6 bits.

In one subembodiment of the embodiment, the third MAC field comprises 11 bits.

In one subembodiment of the embodiment, the third MAC field comprises 12 bits.

In one subembodiment of the embodiment, an index of the second TA is a TA value.

In one subembodiment of the embodiment, an index of the second TA is a non-negative integer.

In one embodiment, the second signaling is a Timing Advance Command MAC CE, and the third MAC field is a field in a Timing Advance Command MAC CE.

In one embodiment, the second signaling is an Absolute Timing Advance Command MAC CE, and the third MAC field is a field in an Absolute Timing Advance Command MAC CE.

In one embodiment, the second signaling is a MAC RAR (Random Access Response), and the third MAC field is a field in an MAC RAR.

In one embodiment, the second signaling is an MSGB, and the third MAC field is a field in an MSGB.

In one embodiment, the second signaling is a fallbackRAR, and the third MAC field is a field in a fallbackRAR.

In one embodiment, the second signaling is a successRAR, and the third MAC field is a field in a successRAR.

In one embodiment, the second signaling comprises the third MAC field, and the second signaling comprises a fourth MAC field, and the fourth field is used to determine a TAG.

In one subembodiment of the embodiment, the fourth MAC field is used to determine a TAG to which the second TA comprised in the third MAC field belongs.

In one subembodiment of the embodiment, the fourth MAC field indicates an index of a TAG to which the second resource group belongs.

In one subembodiment of the embodiment, the fourth MAC field indicates an identifier of a TAG to which the second resource group belongs.

In one subembodiment of the embodiment, the fourth MAC field indicates a TAG-Id associated with the first resource group.

In one embodiment, the behavior of determining an uplink transmission timing of a second resource group according to a second TA comprises: determining an uplink transmission timing of the second resource group according to at least the second TA.

In one embodiment, the behavior of determining an uplink transmission timing of a second resource group according to a second TA comprises: adjusting an uplink transmission timing of the second resource group according to the second TA.

In one embodiment, the behavior of determining an uplink transmission timing of a second resource group according to a second TA comprises: calculating an uplink transmission timing of the second resource group according to the second TA.

In one embodiment, the behavior of determining an uplink transmission timing of a second resource group according to a second TA comprises: determining a transmission time of an uplink signal associated with the second resource group according to the second TA.

In one embodiment, the behavior of determining an uplink transmission timing of a second resource group according to a second TA comprises: determining a transmission time of a PUCCH, an SRS, or PUSCH associated with the second resource group according to the second TA.

In one embodiment, the behavior of determining an uplink transmission timing of a second resource group according to a second TA comprises: determining an uplink transmission timing of the second resource group according to the second TA and maintained N_{TA}.

In one embodiment, the second signaling indicates a second T_{A}, and an uplink transmission timing of the second resource group is determined according to at least the second T_{A}.

In one embodiment, the second signaling indicates a second T_{A}, the second TA is a second N_{TA}, the second N_{TA}=second T_{A}·16·64/2^{μ}; an uplink transmission timing of the second resource group is determined according to the second N_{TA}, and the second T_{A} is an index value of the second TA, a second T_{A}=0, 1, 2, . . . , 3846.

In one embodiment, the second signaling indicates a second T_{A}, and the second TA is (second T_{A}−31)·16·64/2^{μ}; an uplink transmission timing of the second resource group is determined according to a second N_{TA_new}, second N_{TA_new}=second N_{TA_old}+(second T_{A}−31)·16·64/2^{μ}, the second N_{TA_old} is maintained, and the second T_{A} is an index value of the second TA, and second T_{A}=0, 1, 2, . . . , 63.

In one embodiment, the μ₁ is related to an SCS.

In one embodiment, the μ₁ is related to an SCS associated with the second resource group.

In one embodiment, the μ₁ is a non-negative integer.

In one embodiment, the μ₁ is an integer not less than 0 and not greater than 5.

In one embodiment, the μ₁ is equal to the μ₂.

In one embodiment, the μ₁ is not equal to the μ₂.

In one embodiment, the behavior of starting or restarting a second timer comprises: if the second timer is not running, starting the second timer.

In one embodiment, the behavior of starting or restarting a second timer comprises: if the second timer is running, restarting the second timer.

In one embodiment, the second timer is a timer in MAC layer.

In one embodiment, the second timer is a TAT.

In one embodiment, the second timer is a time alignment timer.

In one embodiment, a running state of the second timer is used to determine whether an uplink associated with the second TAG is aligned; the second resource group is associated with the second TAG.

In one embodiment, a running state of the second timer comprises that the second timer is running.

In one embodiment, a running state of the second timer comprises that the second timer is not running.

In one subembodiment of the embodiment, the second timer not being running comprises that the second timer is expired.

In one subembodiment of the embodiment, the second timer not being running comprises that the second timer is not started.

In one embodiment, the second timer being running is used to determine that an uplink associated with the second resource group is aligned.

In one embodiment, the second timer not being running is used to determine that an uplink associated with the second resource group is not aligned.

In one embodiment, the at least one resource group comprises the second resource group.

In one embodiment, the at least one resource group comprises at least the first resource group and the second resource group.

In one embodiment, the at least one resource group only comprises the first resource group and the second resource group.

In one embodiment, an index of any radio resource in the first resource group is different from the index of any radio resource in the second resource group.

In one embodiment, any radio resource in the first resource group does not belong to the second resource group, and any radio resource in the second resource group does not belong to the first resource group.

In one embodiment, whether to execute a third action set is determined according to at least one of whether there exists a time alignment timer associated with any resource group of the first cell being running or a type of the first cell.

In one embodiment, the phrase that the third action set is related to the second cell comprises: the third action set is for the second cell.

In one embodiment, the phrase that the third action set is related to the second cell comprises: the third action set is for each resource group in the second cell.

In one embodiment, each action in the third action set is related to the second cell.

In one embodiment, at least one action in the third action set is related to each resource group in the second cell.

In one embodiment, the third action set is related to all cells other than the first cell in the first cell group.

In one embodiment, the first cell and the second cell are both a cell in the first cell group.

In one embodiment, the first cell is configured with ServCellIndex, and the second cell is configured with ServCellIndex.

In one embodiment, the first cell and the second cell are configured with different ServCellIndexes.

In one embodiment, the first cell and the second cell are not a same cell.

In one embodiment, a PCI of the first cell and a PCI of the second cell are different.

In one embodiment, the first cell and the second cell are connected via CA.

In one embodiment, the action of determining whether to execute a third action set according to at least one of whether the second timer is running or a type of the first cell comprises: whether a third action set is executed is determined according to whether the second timer is running.

In one embodiment, the action of determining whether to execute a third action set according to at least one of whether the second timer is running or a type of the first cell comprises: determining whether to execute a third action set according to a type of the first cell.

In one embodiment, the action of determining whether to execute a third action set according to at least one of whether the second timer is running or a type of the first cell comprises: whether a third action set is executed is determined according to whether the second timer is running and a type of the first cell.

In one embodiment, the action of determining whether to execute a third action set according to at least one of whether the second timer is running or a type of the first cell comprises: if the second timer is not running and the first cell is a primary cell in the first cell group, executing the third action set; the at least one resource group only comprises the first resource group and the second resource group.

In one embodiment, the action of determining whether to execute a third action set according to at least one of whether a timing synchronization timer associated with any resource group of the first cell is running or a type of the first cell comprises: if a timing synchronization timer associated with each resource group of the first cell is not running and is a primary cell in the first cell group, executing the third action set.

In one subembodiment of the embodiment, if a timing synchronization timer associated with any resource group of the first cell is running, the third action set is not executed.

In one subembodiment of the embodiment, a resource group associated with the first cell comprises the second resource group.

In one embodiment, as a response to an expiration of the first timer, only when the second timer is not running and the first cell is a primary cell in the first cell group, execute the third action set; the at least one resource group only comprises the first resource group and the second resource group.

In one embodiment, if the second timer is not running and the first cell is a secondary cell in the first cell group, the third action set is not executed.

In one embodiment, if the second timer is running, the third action set is not executed.

In one embodiment, if the second timer is running and the first cell is a primary cell in the first cell group, the third action set is not executed.

In one embodiment, if the second timer is running and the first cell is a secondary cell in the first cell group, the third action set is not executed.

In one embodiment, if the first cell is a secondary cell in the first cell group, the third action set is not executed.

In one embodiment, as a response to an expiration of the first timer, if at least the second timer is not running and the first cell is a primary cell in the first cell group, execute the third action set; if the second timer is not running and the first cell is a secondary cell in the first cell group, or if the second timer is running, the third action set is not executed.

In one embodiment, as a response to an expiration of the first timer, if a number of resource group(s) in the first cell is greater than 1 and the first cell is a primary cell in the first cell group, execute the second action set.

In one embodiment, as a response to an expiration of the first timer, if a number of resource group(s) in the first cell is greater than 1 and the first cell is a secondary cell in the first cell group, execute the second action set.

In one embodiment, as a response to an expiration of the first timer, if a number of resource group(s) in the first cell is greater than 1 and the second timer is running and the first cell is a primary cell in the first cell group, execute the second action set.

In one embodiment, as a response to an expiration of the first timer, if a number of resource group(s) in the first cell is greater than 1 and the second timer is running and the first cell is a secondary cell in the first cell group, execute the second action set.

In one embodiment, as a response to an expiration of the first timer, if a number of resource group(s) in the first cell is greater than 1 and the second timer is not running and the first cell is a secondary cell in the first cell group, execute the second action set.

In one embodiment, as a response to an expiration of the first timer, if a number of resource group(s) in the first cell is greater than 1 and the second timer is not running and the first cell is a primary cell in the first cell group, execute the second action set and execute the third action set.

In one embodiment, if a number of resource group(s) in the first cell is greater than 1, as a response to an expiration of the first timer, if the second timer is not running and the first cell is a primary cell in the first cell group, execute the second action set and execute the third action set; if the second timer is running and the first cell is a primary cell in the first cell group, or if the second timer is running and the first cell is a secondary cell in the first cell group, or if the second timer is not running and the first cell is a secondary cell in the first cell group, execute the second action set.

In one embodiment, if a number of resource group(s) in the first cell is greater than 1, as a response to an expiration of the first timer, if the second timer is running and the first cell is a primary cell in the first cell group, or if the second timer is running and the first cell is a secondary cell in the first cell group, or if the second timer is not running and the first cell is a secondary cell in the first cell group, the third action set is not executed.

In one embodiment, if a number of resource group(s) in the first cell is greater than 1, as a response to an expiration of the first timer, if the second timer is not running and the first cell is a primary cell in the first cell group, execute the second action set and execute the third action set; otherwise, execute the second action set.

### Embodiment 7

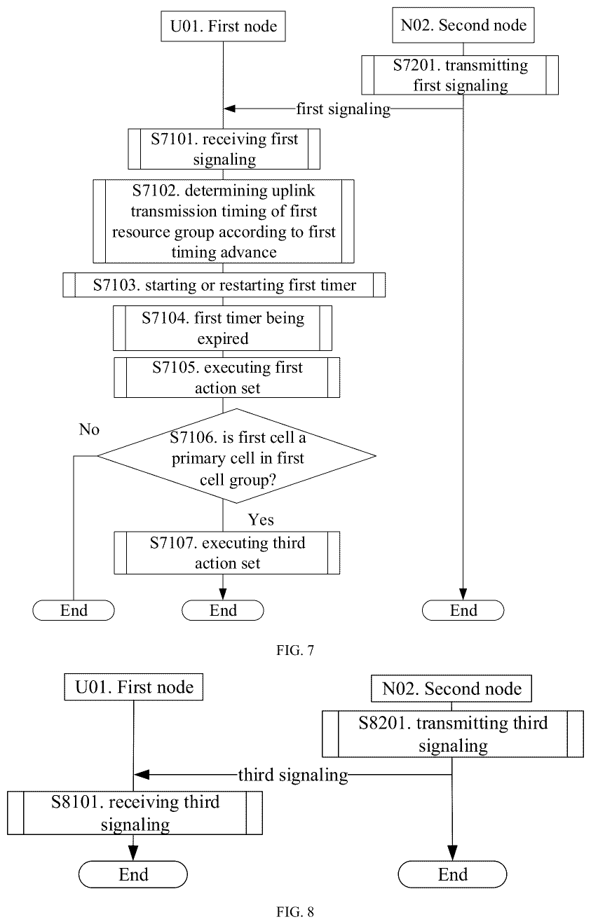

Embodiment 7 illustrates a flowchart of radio signal transmission according to another embodiment in the present application, as shown in FIG. 7. It is particularly underlined that the order illustrated in the embodiment does not put constraints over sequences of signal transmissions and implementations.

The first node U01 receives a first signaling in step S7101, and the first signaling is used to determine a first TA; in step S7102, as a response to the first TA being received, determines an uplink transmission timing of a first resource group according to the first TA, in step S7103, as a response to the first TA being received, starts or restarts a first timer, and a running state of the first timer is used to determine whether an uplink associated with the first resource group is aligned; in step S7104, determines that the first timer expires; in step S7105, as a response to an expiration of the first timer, executes the first action set; in step S7106, determines whether to execute a third action set according to a type of the first cell, if the first cell is a primary cell in the first cell group, enters step S7107; in step S7107, executes the third action set, and the third action set is related to a second cell.

In embodiment 7, the first cell comprises at least one resource group, and each resource group in the at least one resource group comprises at least one radio resource; the first resource group is one of the at least one resource group; the first action set is related to the first cell; the first cell and the second cell belong to a first cell group, and the second cell is any cell other than the first cell in the first cell group; if the first cell is a secondary cell in the first cell group, the third action set is not executed; a number of resource group(s) in the first cell is equal to 1.

In one embodiment, as a response to an expiration of the first timer, if a number of resource group(s) in the first cell is equal to 1, execute the first action set; if a number of resource group(s) in the first cell is greater than 1, executes the second action set.

In one embodiment, as a response to an expiration of the first timer, if a number of resource group(s) in the first cell is equal to 1 and the first cell is a secondary cell in the first cell group, execute the first action set.

In one embodiment, as a response to an expiration of the first timer, if a number of resource group(s) in the first cell is equal to 1 and the first cell is a primary cell in the first cell group, execute the first action set and execute the third action set.

In one embodiment, as a response to an expiration of the first timer, if a number of resource group(s) in the first cell is equal to 1 and the first cell is a primary cell in the first cell group, execute the first action set and execute the third action set; if a number of resource group(s) in the first cell is equal to 1 and the first cell is a secondary cell in the first cell group, execute the first action set.

In one embodiment, if a number of resource group(s) in the first cell is equal to 1, as a response to an expiration of the first timer, if the first cell is a primary cell in the first cell group, execute the first action set and execute the third action set; if the first cell is a primary cell in the first cell group, execute the first action set.

### Embodiment 8

Embodiment 8 illustrates a flowchart of radio signal transmission according to another embodiment in the present application, as shown in FIG. 8. It is particularly underlined that the order illustrated in the embodiment does not put constraints over sequences of signal transmissions and implementations.

The first node U01 receives a third signaling in step S8101, the third signaling is used to determine that the first resource group is associated with a first TAG and the second resource group is associated with a second TAG.

The second node N02 transmits the third signaling in step S8201.

In embodiment 8, the first TAG is different from the second TAG; a number of resource group(s) in the first cell is greater than 1.

In one embodiment, the third signaling is received before the first signaling is received.

In one embodiment, the third signaling is received before the second signaling is received.

In one embodiment, a transmitter of the third signaling is a maintenance base station of the first cell.

In one embodiment, a transmitter of the third signaling is a maintenance base station of a serving cell of the first node.

In one embodiment, a transmitter of the third signaling is a maintenance base station of the first cell.

In one embodiment, a transmitter of the third signaling is a maintenance base station of a cell in the first cell group.

In one embodiment, a transmitter of the third signaling is a maintenance base station of an additional cell of a serving cell of the first node.

In one embodiment, the third signaling comprises at least one RRC message.

In one embodiment, the third signaling comprises at least one RRC field in an RRC message.

In one embodiment, the third signaling comprises at least one RRC IE (Information Element) in an RRC message.

In one embodiment, the third signaling is a Downlink (DL) message.

In one embodiment, the third signaling is a sidelink message.

In one embodiment, the third signaling is transmitted through a DCCH.

In one embodiment, the third signaling comprises an RRCReconfiguration message.

In one embodiment, the third signaling belongs to an RRCReconfiguration message.

In one embodiment, the third signaling comprises a ServingCellConfigCommon IE.

In one embodiment, the third signaling comprises a CellGroupConfig IE.

In one embodiment, the third signaling comprises a ServingCellConfig IE.

In one embodiment, the third signaling is used to configure the first cell group.

In one embodiment, the third signaling is used to configure at least the first cell.

In one embodiment, the third signaling comprises at least ServingCellConfig IE, the ServingCellConfig IE belongs to SpCellConfig, or the ServingCellConfig IE belongs to SCellConfig.

In one subembodiment of the embodiment, the ServingCellConfig IE belonging to SpCellConfig is used to determine that the first cell is an SpCell.

In one subembodiment of the embodiment, the ServingCellConfig IE belongs to SpCellConfig, and SpCellConfig comprising servCellIndex is used to determine that the first cell is a PSCell.

In one subembodiment of the embodiment, the ServingCellConfig IE belongs to SpCellConfig, and SpCellConfig not comprising servCellIndex is used to determine that the first cell is a PCell.

In one subembodiment of the embodiment, the ServingCellConfig IE belonging to SCellConfig is used to determine that the first cell is an SCell.

In one embodiment, a field in the third signaling indicates an index of a first TAG, and another field in the third signaling indicates an index of the second TAG.

In one subembodiment of the embodiment, the field and the another field belong to UplinkConfigCommon IE.

In one subembodiment of the embodiment, the field and the another field belong to BWP-UplinkCommon.

In one subembodiment of the embodiment, the field and the another field belong to BWP-UplinkDedicated.

In one subembodiment of the embodiment, the field and the another field belong to BWP-Uplink.

In one subembodiment of the embodiment, the field and the another field belong to ServingCellConfig IE.

In one subembodiment of the embodiment, a name of the RRC field is the same as a name of the another RRC field.

In one subembodiment of the embodiment, a name of the RRC field and a name of the another RRC field comprise TAG-Id.

In one subembodiment of the embodiment, a value of the RRC field is different from a value of the another RRC field.

In one embodiment, the third signaling comprises M1 indexes, the M1 indexes correspond to M1 TAGs, and each TAG in the M1 TAGs comprises at least one resource group in the first cell group; each of the M1 indexes is an index of a TAG, and the M1 indexes are associated with the first cell.

In one embodiment, the third signaling configures an index of the first TAG for the first reference resource group, and the third signaling configures an index of the second TAG for the second reference resource group; the first reference resource group is associated with the first resource group, and the second reference resource group is associated with the second resource group.

In one embodiment, the third signaling is used to determine that each resource group in the first cell is associated with a TAG.

In one embodiment, the first TAG comprises at least one resource group, and each resource group in the at least one resource group belongs to a cell in the first cell group.

In one embodiment, the first TAG comprises at least the first resource group.

In one embodiment, the first TAG only comprises one resource group.

In one embodiment, the first TAG comprises one or more resource groups.

In one embodiment, the first TAG is a TAG.

In one embodiment, the first TAG is an enhanced TAG.

In one embodiment, the first TAG is a resource group granularity TAG.

In one embodiment, the first TAG is a cell granularity TAG.

In one embodiment, the first TAG is identified by TAG-Id.

In one embodiment, the first TAG is identified by an index of the first TAG.

In one embodiment, an index of the first TAG is a non-negative integer.

In one embodiment, an index of the first TAG is an integer not less than 0 and not greater than P1.

In one embodiment, P1 is equal to 3 or 4 or 5 or 6 or 7 or 8.

In one embodiment, the first TAG is a PTAG (Primary TA Group).

In one embodiment, the first TAG is an STAG (Secondary TA Group).

In one embodiment, the second TAG comprises at least one resource group, and each resource group in the at least one resource group belongs to a cell in the first cell group.

In one embodiment, the second TAG comprises at least the second resource group.

In one embodiment, the second TAG only comprises one resource group.

In one embodiment, the second TAG comprises one or more resource groups.

In one embodiment, the second TAG is a TAG.

In one embodiment, the second TAG is an enhanced TAG.

In one embodiment, the second TAG is a resource group granularity TAG.

In one embodiment, the second TAG is a cell granularity TAG.

In one embodiment, the second TAG is identified by TAG-Id.

In one embodiment, the second TAG is identified by an index of the first TAG.

In one embodiment, an index of the second TAG is a non-negative integer.

In one embodiment, an index of the second TAG is an integer not less than 0 and not greater than P1.

In one embodiment, the second TAG is a PTAG (Primary TA Group).

In one embodiment, the second TAG is an STAG (Secondary TA Group).

In one embodiment, an index of the first TAG and an index of the second TAG are not equal.

In one embodiment, the first TAG and the second TAG belong to the first cell group.

In one embodiment, any resource group comprised in the first TAG is different from any resource group comprised in the second TAG.

In one embodiment, at least one resource group comprised in the first TAG does not belong to the second TAG.

In one embodiment, as a response to the first TA being received, apply the first TA for the first TAG; the behavior of applying the first TA for the first TAG is used to determine the behavior of determining an uplink transmission timing of a first resource group according to the first TA.

In one embodiment, as a response to the second TA being received, apply the second TA for the second TAG; the behavior of applying the second TA for the second TAG is used to determine the behavior of determining an uplink transmission timing of a second resource group according to the second TA.

### Embodiment 9

Embodiment 9 illustrates a schematic diagram of a third action set being related to a second cell according to one embodiment of the present application.

In embodiment 9, the third action set comprises at least one of flushing all HARQ buffers associated with the second cell, or considering that a third timer is expired, or notifying an upper layer to release all first-type resources associated with the second cell; a running state of the third timer is used to determine whether an uplink associated with a third resource group is aligned, and the third resource group is associated with the second cell.

In one embodiment, the third action set comprises at least one of flushing all HARQ buffers associated with all cells other than the first cell in the first cell group, or considering that time alignment timers associated with all cells other than the first cell in the first cell group are expired, or notifying an upper layer to release all first-type resources associated with all cells other than the first cell in the first cell group.

In one embodiment, the behavior of performing the first action set and the third action set comprises: at least one of flushing all HARQ buffers associated with all cells in the first cell group, or considering that time alignment timers associated with all cells in the first cell group are expired, or notifying an upper layer to release all first-type resources associated with all cells in the first cell group, or deleting all second-type resources associated with the first cell group.

In one embodiment, all cells other than the first cell in the first cell group comprise the second cell.

In one embodiment, the second cell is any cell in all cells other than the first cell in the first cell group.

In one embodiment, the third timer is a timer in MAC layer.

In one embodiment, the third timer is a TAT.

In one embodiment, the third timer is a time-aligned timer.

In one embodiment, a running state of the third timer is used to determine whether an uplink associated with the third TAG is aligned; the third resource group is associated with the third TAG.

In one embodiment, the third timer being running is used to determine that an uplink associated with the third resource group is aligned.

In one embodiment, the third timer not being running is used to determine that an uplink associated with the third resource group is not aligned.

In one embodiment, the third timer not being running comprises: the third timer being expired.

In one embodiment, the third timer not being running comprises: the third timer is not started and is not restarted.

In one embodiment, the third timer is running when the first timer expires.

In one embodiment, the third timer is not running when the first timer expires.

In one embodiment, when the first timer expires, if the third timer is running, the third action set comprises considering that the third timer expires.

In one embodiment, if the second cell only comprises one resource group, a running state of the third timer is used to determine whether an uplink associated with the second cell is aligned.

In one embodiment, the third action set comprises at least one of flushing all HARQ buffers associated with the second cell, or considering that a third timer is expired, or notifying an upper layer to release all first-type resources associated with the second cell; a running state of the third timer is used to determine whether an uplink associated with a third resource group is aligned, and the third resource group is associated with the second cell; a number of resource group(s) in the second cell is equal to 1.

In one embodiment, the third action set comprises at least one of flushing all HARQ buffers associated with all resource groups in the second cell, or considering that all running time alignment timers associated with all resource groups in the second cell are expired, or notifying an upper layer to release all first-type resources associated with all resource groups in the second cell; a number of resource group(s) in the second cell is greater than 1.

In one embodiment, the third action set is related to all cells other than the first cell in the first cell group.

In one embodiment, the third action set comprises at least one of flushing all HARQ buffers associated with all cells other than the first cell in the first cell group, or considering that all running time alignment timers other than the first cell in the first cell group are expired, or notifying an upper layer to release all first-type resources associated with all cells other than the first cell in the first cell group.

In one embodiment, the behavior of executing the first action set and executing the third action set comprises: flushing all HARQ buffers associated with each cell in the first cell group.

In one embodiment, the behavior of executing the first action set and executing the third action set comprises: notifying an upper layer to release all first-type resources associated with each cell in the first cell group.

In one embodiment, the behavior of executing the first action set and executing the third action set comprises: deleting all second-type resources associated with each cell in the first cell group.

In one embodiment, the behavior of executing the first action set and executing the third action set comprises: deleting all second-type resources associated with a MAC entity to which the first cell group belongs.

In one embodiment, the behavior of executing the first action set and executing the third action set comprises: considering that all running time alignment timers associated with the first cell group are expired.

In one embodiment, the behavior of executing the first action set and executing the third action set comprises: at least one of flushing all HARQ buffers associated with each cell in the first cell group, or notifying an upper layer to release all first-type resources associated with each cell in the first cell group, or deleting all second-type resources associated with each cell in the first cell group, or deleting all second-type resources associated with a MAC entity to which the first cell group belongs, or considering that all running time alignment timers associated with the first cell group are expired.

In one embodiment, the behavior of executing the second action set and executing the third action set comprises: flushing all HARQ buffers associated with each cell in the first cell group.

In one embodiment, the behavior of executing the second action set and executing the third action set comprises: notifying an upper layer to release all first-type resources associated with each cell in the first cell group.

In one embodiment, the behavior of executing the second action set and executing the third action set comprises: deleting all second-type resources associated with each cell in the first cell group.

In one embodiment, the behavior of executing the second action set and executing the third action set comprises: deleting all second-type resources associated with a MAC entity to which the first cell group belongs.

In one embodiment, the behavior of executing the second action set and executing the third action set comprises: considering that all running time alignment timers associated with the first cell group are expired.

In one embodiment, the behavior of executing the second action set and executing the third action set comprises: at least one of flushing all HARQ buffers associated with each cell in the first cell group, or notifying an upper layer to release all first-type resources associated with each cell in the first cell group, or deleting all second-type resources associated with each cell in the first cell group, or deleting all second-type resources associated with a MAC entity to which the first cell group belongs, or considering that all running time alignment timers associated with the first cell group are expired.

In one embodiment, the third signaling is used to determine that the first resource group is associated with the first TAG, the second resource group is associated with the second TAG, and the third resource group is associated with the third TAG.

### Embodiment 10

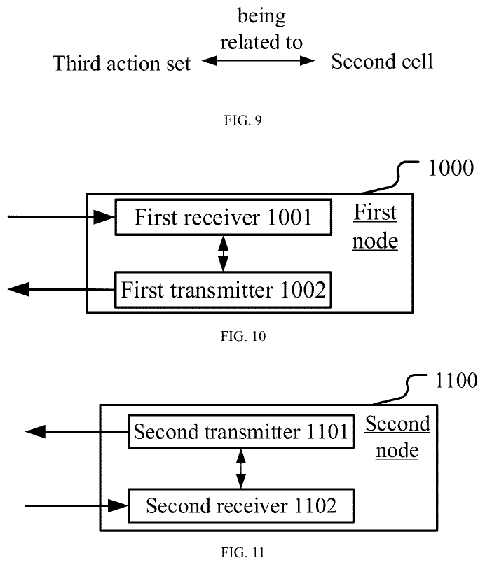

Embodiment 10 illustrates a structure block diagram of a processor in a first node according to one embodiment of the present application, as shown in FIG. 10. In FIG. 10, a processor 1000 in a first node comprises a first receiver 1001 and a first transmitter 1002.

A first receiver 1001 receives a first signaling, the first signaling is used to indicate a first TA;
a first transmitter 1002, as a response to the first TA being received, determines an uplink transmission timing of a first resource group according to the first TA, and starts or restarts a first timer, a running state of the first timer is used to determine whether an uplink associated with the first resource group is aligned; as a response to an expiration of the first timer, determines whether to execute a first action set or a second action set according to at least a number of resource group(s) in a first cell;

In embodiment 10, the first cell comprises at least one resource group, and each resource group in the at least one resource group comprises at least one radio resource; the first resource group is one of the at least one resource group; the behavior of determining whether to execute a first action set or a second action set according to at least a number of resource group(s) in a first cell comprises: if a number of resource group(s) in the first cell is equal to 1, executing the first action set, the first action set being related to the first cell; if a number of resource group(s) in the first cell is greater than 1, executing the second action set, the second action set being related to the first resource group, and the second action set being unrelated to a resource group other than the first resource group in the first cell.

In one embodiment, the first action set comprises flushing all HARQ buffers associated with the first cell; the second action set comprises flushing all HARQ buffers associated with the first resource group.

In one embodiment, the first action set comprises notifying an upper layer to release all first-type resources associated with the first cell; the second action set comprises notifying an upper layer to release all first-type resources associated with the first resource group; the first-type resource comprises at least one of a PUCCH or an SRS.

In one embodiment, the first action set comprises deleting all second-type resources associated with the first cell; the second action set comprises deleting all second-type resources associated with the first resource group; the second-type resource comprises at least one of a configured downlink assignment, or a configured uplink grant, or PUSCH resources for semi-persistent CSI reporting.

In one embodiment, the first receiver 1001 receives a second signaling, and the second signaling is used to determine a second TA; the first transmitter 1002, as a response to the second TA being received, determines an uplink transmission timing of a second resource group according to the second TA, and starts or restarts a second timer, a running state of the second timer is used to determine whether an uplink associated with the second resource group is aligned; herein, the second resource group is one of the at least one resource group; any radio resource in the first resource group is different from any radio resource in the second resource group.

In one embodiment, the first transmitter 1002, as a response to an expiration of the first timer, if a number of resource group(s) in the first cell is greater than 1, determines whether to execute a third action set according to at least one of whether the second timer is running or a type of the first cell, and the third action set is related to a second cell; herein, the first cell and the second cell belong to a first cell group, and the second cell is any cell other than the first cell in the first cell group; the action of determining whether to execute a third action set according to at least one of whether the second timer is running or a type of the first cell comprises: if at least the second timer is not running and the first cell is a primary cell in the first cell group, executing the third action set.

In one embodiment, the third action set comprises at least one of flushing all HARQ buffers associated with the second cell, or considering that a third timer is expired, or notifying an upper layer to release all first-type resources associated with the second cell; a running state of the third timer is used to determine whether an uplink associated with a third resource group is aligned, and the third resource group is associated with the second cell.

In one embodiment, the first transmitter 1002, as a response to an expiration of the first timer, if a number of resource group(s) in the first cell is equal to 1, determines whether to execute a third action set according to a type of the first cell, the third action set is related to a second cell; herein, the first cell and the second cell belong to a first cell group, and the second cell is any cell other than the first cell in the first cell group; the action of determining whether to execute a third action set according to a type of the first cell comprises: if the first cell is a primary cell in the first cell group, executing the third action set; if the first cell is a secondary cell in the first cell group, the third action set not being executed.

In one embodiment, the first receiver 1001 receives a third signaling, the third signaling is used to determine that the first resource group is associated with a first TAG and the second resource group is associated with a second TAG; herein, the first TAG is different from the second TAG.

In one embodiment, the first transmitter 1002 transmits at least a first radio signal according to an uplink transmission timing of the first resource group, the first radio signal is a physical-layer signal; a number of resource group(s) in the first cell is greater than 1.

In one embodiment, the first transmitter 1002 transmits at least a second radio signal according to an uplink transmission timing of the second resource group, the second radio signal is a physical-layer signal; a number of resource group(s) in the first cell is greater than 1.

In one embodiment, the first receiver 1001 comprises the antenna 452, the receiver 454, the multi-antenna receiving processor 458, the receiving processor 456, the controller/processor 459, the memory 460 and the data source 467 in FIG. 4 of the present application.

In one embodiment, the first receiver 1001 comprises the antenna 452, the receiver 454, the multi-antenna receiving processor 458 and the receiving processor 456 in FIG. 4 of the present application.

In one embodiment, the first receiver 1001 comprises the antenna 452, the receiver 454 and the receiving processor 456 in FIG. 4 of the present application.

In one embodiment, the first transmitter 1002 comprises the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1002 comprises the antenna 452, the transmitter 454, the multi-antenna transmitting processor 457 and the transmitting processor 468 in FIG. 4 of the present application.

In one embodiment, the first transmitter 1002 comprises the antenna 452, the transmitter 454 and the transmitting processor 468 in FIG. 4 of the present application.

### Embodiment 11

Embodiment 11 illustrates a structure block diagram of a processor in a second node according to one embodiment of the present application, as shown in FIG. 11. In FIG. 11, a processor 1100 in a second node comprises a second transmitter 1101 and a second receiver 1102.

A second transmitter 1101 transmits a first signaling, the first signaling is used to indicate a first TA;
In embodiment 11, as a response to the first TA being received, an uplink transmission timing of a first resource group is determined by a receiver of the first signaling according to the first TA, a first timer is started or restarted by a receiver of the first signaling, and a running state of the first timer is used to determine whether an uplink associated with the first resource group is aligned; as a response to an expiration of the first timer, at least a number of resource group(s) in a first cell is used to determine whether to execute a first action set or a second action set; the first cell comprises at least one resource group, and each resource group in the at least one resource group comprises at least one radio resource; the first resource group is one of the at least one resource group; the phrase that at least a number of resource group(s) in a first cell is used to determine whether to execute a first action set or a second action set comprises: if a number of resource group(s) in the first cell is equal to 1, the first action set being executed, the first action set being related to the first cell; if a number of resource group(s) in the first cell is greater than 1, the second action set being executed, the second action set being related to the first resource group, and the second action set being unrelated to a resource group other than the first resource group in the first cell.

In one embodiment, the first action set comprises flushing all HARQ buffers associated with the first cell; the second action set comprises flushing all HARQ buffers associated with the first resource group.

In one embodiment, the first action set comprises notifying an upper layer to release all first-type resources associated with the first cell; the second action set comprises notifying an upper layer to release all first-type resources associated with the first resource group; the first-type resource comprises at least one of a PUCCH or an SRS.

In one embodiment, the first action set comprises deleting all second-type resources associated with the first cell; the second action set comprises deleting all second-type resources associated with the first resource group; the second-type resource comprises at least one of a configured downlink assignment, or a configured uplink grant, or PUSCH resources for semi-persistent CSI reporting.

In one embodiment, the second transmitter 1101 transmits a second signaling, and the second signaling is used to determine a second TA; herein, as a response to the second TA being received, an uplink transmission timing of a second resource group is determined by a receiver of the first signaling according to the second TA, and a second timer is started or restarted by a receiver of the first signaling, a running state of the second timer is used to determine whether an uplink associated with the second resource group is aligned; the second resource group is one of the at least one resource group; any radio resource in the first resource group is different from any radio resource in the second resource group.

In one embodiment, as a response to an expiration of the first timer, if a number of resource group(s) in the first cell is greater than 1, at least one of whether the second timer is running or a type of the first cell is used to determine whether to execute a third action set, and the third action set is related to a second cell; the first cell and the second cell belong to a first cell group, and the second cell is any cell other than the first cell in the first cell group; the phrase of at least one of whether the second timer is running or a type of the first cell is used to determine whether to perform a third action set comprises: if at least the second timer is not running and the first cell is a primary cell in the first cell group, the third action set is executed.

In one embodiment, the third action set comprises at least one of flushing all HARQ buffers associated with the second cell, or considering that a third timer is expired, or notifying an upper layer to release all first-type resources associated with the second cell; a running state of the third timer is used to determine whether an uplink associated with a third resource group is aligned, and the third resource group is associated with the second cell.

In one embodiment, as a response to an expiration of the first timer, if a number of resource group(s) in the first cell is equal to 1, a type of the first cell is used to determine whether to execute a third action set, the third action set being related to a second cell; herein, the first cell and the second cell belong to a first cell group, and the second cell is any cell other than the first cell in the first cell group; the phrase that a type of the first cell is used to determine whether to execute a third action set comprises: if the first cell is a primary cell in the first cell group, the third action set is executed; if the first cell is a secondary cell in the first cell group, the third action set is not executed.

In one embodiment, the second transmitter 1101 transmits a third signaling, the third signaling is used to determine that the first resource group is associated with a first TAG and the second resource group is associated with a second TAG; herein, the first TAG is different from the second TAG.

In one embodiment, the second receiver 1102 receives at least a first radio signal; the at least first radio signal is transmitted according to an uplink transmission timing of the first resource group, the first radio signal is a physical-layer signal; a number of resource group(s) in the first cell is greater than 1.

In one embodiment, the second receiver 1102 receives at least a second radio signal; the at least a second radio signal is transmitted according to an uplink transmission timing of the second resource group, the second radio signal is a physical-layer signal; a number of resource group(s) in the first cell is greater than 1.

In one embodiment, the second transmitter 1101 comprises the antenna 420, the transmitter 418, the multi-antenna transmitting processor 471, the transmitting processor 416, the controller/processor 475 and the memory 476 in FIG. 4 of the present application.

In one embodiment, the second transmitter 1101 comprises the antenna 420, the transmitter 418, the multi-antenna transmitting processor 471 and the transmitting processor 416 in FIG. 4 of the present application.

In one embodiment, the second transmitter 1101 comprises the antenna 420, the transmitter 418 and the transmitting processor 416 in FIG. 4 of the present application.

In one embodiment, the second receiver 1102 comprises the antenna 420, the receiver 418, the multi-antenna receiving processor 472, the receiving processor 470, the controller/processor 475 and the memory 476 in FIG. 4 of the present application.

In one embodiment, the second receiver 1102 comprises the antenna 420, the receiver 418, the multi-antenna receiving processor 472 and the receiving processor 470 in FIG. 4 of the present application.

In one embodiment, the second receiver 1102 comprises the antenna 420, the receiver 418 and the receiving processor 470 in FIG. 4 of the present application.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, wireless sensors, network cards, Internet of Things (IoT) terminals, RFID terminals, NB-IoT terminals, Machine Type Communication (MTC) terminals, enhanced MTC (CMTC) terminals, data card, network cards, vehicle-mounted communication equipment, low-cost mobile phones, low-cost tablets and other wireless communication devices. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IoT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first signaling, the first signaling being used to indicate a first TA (Timing Advance); and
a first transmitter, as a response to the first TA being received, determining an uplink transmission timing of a first resource group according to the first TA, starting or restarting a first timer, and a running state of the first timer being used to determine whether an uplink associated with the first resource group is aligned; as a response to an expiration of the first timer, determining whether to execute a first action set or a second action set according to at least a number of resource group(s) in a first cell;
wherein the first cell comprises at least one resource group, and each resource group in the at least one resource group comprises at least one radio resource; the first resource group is one of the at least one resource group; the behavior of determining whether to execute a first action set or a second action set according to at least a number of resource group(s) in a first cell comprises: if a number of resource group(s) in the first cell is equal to 1, executing the first action set, the first action set being related to the first cell; if a number of resource group(s) in the first cell is greater than 1, executing the second action set, the second action set being related to the first resource group, and the second action set being unrelated to a resource group other than the first resource group in the first cell.

2. The first node according to claim 1, wherein the first action set comprises fulshing all HARQ buffers associated with the first cell, notifying an upper layer to release all first-type resources associated with the first cell, deleting all second-type resources associated with the first cell; the second action set comprises deleting all second-type resources associated with the first resource group; the first-type resource comprises at least one of a PUCCH or an SRS; the second-type resource comprises at least one of a configured downlink assignment, or a configured uplink grant, or PUSCH resources for semi-persistent CSI reporting: the upper layer is an RRC layer.

3. The first node according to claim 1, comprising:
the first receiver, receiving a second signaling, the second signaling being used to determine a second TA; and
the first transmitter, as a response to the second TA being received, determining an uplink transmission timing of a second resource group according to the second TA, starting or restarting a second timer, and a running state of the second timer being used to determine whether an uplink associated with the second resource group is aligned;
wherein the second resource group is one of the at least one resource group; any radio resource in the first resource group is different from any radio resource in the second resource group; a number of resource group(s) in the first cell is greater than 1.

4. The first node according to claim 3, wherein the second signaling comprises a third MAC field, the third MAC field is used to determine the second TA, the third MAC field comprises 12 bits, and the second signaling comprises a fourth MAC field, the fourth MAC field is used to determine a TAG to which the second TA comprised in the third MAC field belongs.

5. The first node according to claim 4, wherein the second signaling is a MAC RAR, and the third MAC field is a field in a MAC RAR: or, the second signaling is fallbackRAR, and the third MAC field is a field in fallbackRAR.

6. The first node according to claim 3, wherein each resource group in the at least one resource group belongs to the first cell or an additional cell of the first cell; a PCI of the first cell and a PCI of the additional cell of the first cell are different: the first node is configured with an SSB in the first cell, the SSB is configured by CSI-SSB-ResourceSet IE, the CSI-SSB-ResourceSet IE comprises an RRC (Radio Resource Control) field, and the RRC field is used to indicate that the SSB belongs to the additional cell of the first cell.

7. The first node according to claim 3, comprising:
the first transmitter, as a response to an expiration of the first timer, if a number of resource group(s) in the first cell is greater than 1, determining whether to execute a third action set according to at least one of whether the second timer is running or a type of the first cell, the third action set being related to a second cell;
wherein the first cell and the second cell belong to a first cell group, and the second cell is any cell other than the first cell in the first cell group; the action of determining whether to execute a third action set according to at least one of whether the second timer is running or a type of the first cell comprises: if at least the second timer is not running and the first cell is a primary cell in the first cell group, executing the third action set.

8. The first node according to claim 7, wherein if the second timer is running and the first cell is a primary cell in the first cell group, the third action set is not executed: the second timer is a timeAlignmentTimer.

9. The first node according to claim 1, comprising:
the first transmitter, as a response to an expiration of the first timer, determining whether to execute a third action set according to a type of the first cell, the third action set being related to a second cell;
wherein the first cell and the second cell belong to a first cell group, and the second cell is any cell other than the first cell in the first cell group; the action of determining whether to execute a third action set according to a type of the first cell comprises: if the first cell is a primary cell in the first cell group, executing the third action set; if the first cell is a secondary cell in the first cell group, the third action set not being executed: a number of resource group(s) in the first cell is equal to 1.

10. The first node according to claim 7, wherein the third action set comprises at least one of flushing all HARQ buffers associated with the second cell, or considering that a third timer is expired, or notifying an upper layer to release all first-type resources associated with the second cell; a running state of the third timer is used to determine whether an uplink associated with a third resource group is aligned, and the third resource group is associated with the second cell.

11. The first node according to claim 3, comprising:
the first receiver, receiving a third signaling, the third signaling being used to determine that the first resource group is associated with a first TAG and the second resource group is associated with a second TAG;
wherein the first TAG is different from the second TAG.

12. The first node according to claim 11, wherein the third signaling comprises a ServingCellConfig IE: a field in the third signaling indicates an index of a first TAG, and another field in the third signaling indicates an index of the second TAG; the field and the another field belong to ServingCellConfig IE.

13. The first node according to claim 11, wherein the first TAG is identified by TAG-Id: the second TAG is identified by TAG-Id: an index of the first TAG and an index of the second TAG are not equal.

14. The first node according to claim 1, wherein a number of resource group(s) comprised in each cell in the first cell group is configurable: a number of resource group(s) comprised in each cell in the first cell group is equal to 1 or 2: there exists at least one cell whose comprised number of resource group(s) being greater than 1 in the first cell group.

15. The first node according to claim 14, wherein the first cell group is an MCG, a primary cell in the first cell group is a PCell, and a secondary cell in the first cell group is an SCell:
or,
the first cell group is an SCG, a primary cell in the first cell group is a PSCell, and a secondary cell in the first cell group is an SCell.

16. The first node according to claim 1, wherein if a number of resource group(s) in the first cell is greater than 1 comprises: if a number of resource group(s) in the first cell is equal to 2: the first timer is a timeAlignmentTimer.

17. The first node according to claim 1, wherein the first signaling comprises a first MAC field, the first MAC field is used to determine the first TA, the first MAC field comprises 12 bits, the first signaling comprises a second MAC field, and the second MAC field is used to determine a TAG to which the first TA comprised in the first MAC field belongs.

18. The first node according to claim 17, wherein the first signaling is a MAC RAR, and the first MAC field is a field in a MAC RAR: or, the first signaling is fallbackRAR, and the first MAC field is a field in fallbackRAR.

19. A method in a first node for wireless communications, comprising:
receiving a first signaling, the first signaling being used to indicate a first TA;
as a response to the first TA being received, determining an uplink transmission timing of a first resource group according to the first TA, starting or restarting a first timer, and a running state of the first timer being used to determine whether an uplink associated with the first resource group is aligned; as a response to an expiration of the first timer, determining whether to execute a first action set or a second action set according to at least a number of resource group(s) in a first cell;
wherein the first cell comprises at least one resource group, and each resource group in the at least one resource group comprises at least one radio resource; the first resource group is one of the at least one resource group; the behavior of determining whether to execute a first action set or a second action set according to at least a number of resource group(s) in a first cell comprises: if a number of resource group(s) in the first cell is equal to 1, executing the first action set, the first action set being related to the first cell; if a number of resource group(s) in the first cell is greater than 1, executing the second action set, the second action set being related to the first resource group, and the second action set being unrelated to a resource group other than the first resource group in the first cell.

20. A second node for wireless communications, comprising:
a second transmitter, transmitting a first signaling, the first signaling being used to indicate a first TA; wherein as a response to the first TA being received, an uplink transmission timing of a first resource group is determined by a receiver of the first signaling according to the first TA, a first timer is started or restarted by a receiver of the first signaling, and a running state of the first timer is used to determine whether an uplink associated with the first resource group is aligned; as a response to an expiration of the first timer, at least a number of resource group(s) in a first cell is used to determine whether to execute a first action set or a second action set; the first cell comprises at least one resource group, and each resource group in the at least one resource group comprises at least one radio resource; the first resource group is one of the at least one resource group; the phrase that at least a number of resource group(s) in a first cell is used to determine whether to execute a first action set or a second action set comprises: if a number of resource group(s) in the first cell is equal to 1, the first action set being executed, the first action set being related to the first cell; if a number of resource group(s) in the first cell is greater than 1, the second action set being executed, the second action set being related to the first resource group, and the second action set being unrelated to a resource group other than the first resource group in the first cell.
